(19) United States
(12) Patent Application Publication
(10) Pub. No.: US 2024/0344163 A1
(43) Pub. Date: Oct. 17, 2024

(54) Methods and Apparatuses Related to Payload Launch Vehicles

(71) Applicant: Relativity Space, Inc., Long Beach, CA (US)

(72) Inventors: Jordan Noone, Long Beach, CA (US); Timothy A. Ellis, Long Beach, CA (US); John Rising, Inglewood, CA (US)

(73) Assignee: Relativity Space, Inc., Long Beach, CA (US)

(21) Appl. No.: 18/753,762

(22) Filed: Jun. 25, 2024

Related U.S. Application Data
(63) Continuation of application No. 18/146,292, filed on Dec. 23, 2022.
Application No. 18/146,292 is a continuation of application No. 15/464,675, filed on Mar. 21, 2017, now abandoned.
(60) Provisional application No. 62/311,348, filed on Mar. 21, 2016.
(60) Provisional application No. 62/406,348, filed on Oct. 10, 2016.

(51) Int. Cl. C21D 9/00; B23K 15/00; B23K 15/02; B23K 26/342; B23K 26/70; B28B 1/00; B33Y 10/00; B33Y 30/00; B33Y 40/00; B33Y 50/02; B33Y 80/00; B64G 1/00; B64G 1/22; C21D 1/30; C21D 1/60; C21D 1/613; C21D 7/06

(52) U.S. Cl. CPC C21D 9/0068; B23K 15/0026; B23K 15/0086; B23K 15/02; B23K 26/342; B23K 26/702; B28B 1/001; B33Y 10/00; B33Y 30/00; B33Y 40/00; B33Y 50/02; B33Y 80/00; B64G 1/002; B64G 1/22; C21D 1/30; C21D 1/60; C21D 1/613; C21D 7/06

(57) ABSTRACT

Systems and methods for additive layer manufacturing of metallic components, such as rocket engines and propellant supply systems, are provided. Methods include melting the surface of a work piece to form a weld pool; adding wire to the weld pool and moving a heat source relative to the work piece to progressively form a new layer of metallic material on the work piece; cooling the formed layer; stress relieving (e.g., peening) the cooled layer; applying a secondary operations either sequentially or simultaneously; and repeating the above steps as required to form components layer by layer. Systems and methods of supplying a first propellant to the rocket engine of a launch vehicle are also provided, where the first propellant is supplied through a heat exchanger for generating mechanical energy to pump the first propellant into the rocket engine, and electrical energy to pump a second propellant into the rocket engine.

### RELATED APPLICATIONS

This Application is a continuation of U.S. patent application Ser. No. 18/146,292 filed Dec. 23, 2022, which is a continuation of U.S. patent application Ser. No. 15/464,675 filed Mar. 21, 2017, which claims priority under 35 U.S.C. 119 (c) to U.S. Provisional Patent Application No. 62/311,348 filed Mar. 21, 2016 and U.S. Provisional Patent Application No. 62/406,348 filed Oct. 10, 2016, the disclosures of which are incorporated herein by reference in their entireties.

### BACKGROUND

Conventional additive layer manufacturing (ALM) is a consolidation process that is able to produce a functional complex part, layer by layer, without molds or dies. This process uses a powerful heat source such as a laser beam or an electron beam to melt a controlled amount of metal in the form of metallic wire, which is then deposited, initially, on a base plate. Subsequent layers are then built up upon each preceding layer. As opposed to conventional machining processes, this computer-aided manufacturing (CAM) technology builds complete functional parts or, alternatively, builds features on existing components, by adding material rather than by removing it.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### SUMMARY

In some aspects, methods disclosed herein comprise: applying an amount of heat to a portion of a work piece sufficient to melt the portion of the work piece thereby forming a melted portion of the work piece; depositing a deposition material to the melted portion of the work piece to form a layer of deposition material on the work piece; and cooling said layer of deposition material on the work piece to a crystallization state of the deposition material. In some embodiments, the methods comprise moving the source of heat relative to the work piece to continuously form melted portions of the work piece; continuously depositing deposition material to the melted portions of the work piece to form a continuous layer of the deposition material on the work piece; and continuously cooling the continuous layer of the deposition material on the work piece. In some embodiments, the methods comprise continuously cooling the continuous layer comprises continuously cooling the portion of the continuous layer immediately adjacent to the deposited portion of the continuous layer. In some embodiments, the methods comprise continuously cooling occurs simultaneously with continuously depositing. In some embodiments, the methods comprise stress relieving the cooled layer of the work piece. In some embodiments, the methods comprise machining the work piece to form a component. In some embodiments, the component comprises a structural component of an orbital vehicle or launch vehicle.

In some aspects, apparatuses disclosed herein comprise a heat source to heat a portion of a work piece sufficient to form a melted portion of the work piece; an applicator to deposit a deposition material to the melted portion of the work piece to form a layer of deposition material on the work piece; and a cooler to cool the layer of deposition material on the work piece to a crystallization state of the deposition material. In some embodiments, the apparatus comprises a stress-relieving apparatus configured to apply a stress-relieving process on the cooled layer of deposition material on the work piece. In some embodiments, the stress-relieving apparatus comprises a peening module. In some embodiments, the cooler comprises at least one of a gas cooler or a cryogenic cooler. In some embodiments, the apparatus comprises a wire straightening device. In some embodiments, the wire straightening device comprises a roller arrangement. In some embodiments, the wire straightening device comprises a static blade arrangement. In some embodiments, the wire straightening device comprises a heating device. In some embodiments, the heating device heats by electric resistive heating, inductive heating, radiative heating, conduction heating, convective heating, or a combination thereof. In some embodiments, the apparatus comprises a tensioning element. In some embodiments, the apparatus comprises a trowel device. In some embodiments, the apparatus comprises a moveable armature, wherein the trowel device is attached to the applicator by the moveable armature. In some embodiments, the trowel device comprises a material selected from a ceramic material and a refractory metallic material. In some embodiments, the apparatus comprises a roller device. In some embodiments, the roller device is attached to the applicator by the moveable armature. In some embodiments, the applicator comprises a print head. In some embodiments, at least a portion of the deposition material is in a form of a wire. In some embodiments, the wire is fed from a wire feeder system. In some embodiments, the wire is fed from a wire feeder guide tip mounted on the print head. In some embodiments, the wire feeder guide tip comprises a cooling system. In some embodiments, the print head comprises an optic device that focuses an energy beam onto the wire. In some embodiments, the cooler cools at least one surface exposed to the energy beam.

In some aspects, methods disclosed herein form a metallic component by additive layer manufacturing including the steps of: a) using a heat source to apply heat to a portion of a surface of a work piece sufficient to form a melted portion; b) adding metallic material to the melted portion and moving a heat source relative to the work piece to form a formed layer of metallic material on the work piece; c) applying forced cooling to the formed layer to bring the layer to a state of crystallization; d) stress relieving said formed layer; e) machining operations on a component portion and repeating steps a) to e) as required whereby to form the component. In some embodiments, the steps are performed simultaneously. In some embodiments, the additive manufacturing method is selected from the group consisting of laser wire manufacture and electron beam wire manufacture of a wire. In some embodiments, stress relieving the layer comprises applying high frequency peening to the layer. In some embodiments, the high frequency peening comprises applying a pulsed laser to the layer. In some embodiments, the high frequency peening comprises applying ultrasonic impact treatment to the layer. In some embodiments, stress relieving the layer comprises applying high-pressure rolling to the layer. In some embodiments, the forced layer cooling comprises applying at least one of gas cooling, liquid cooling, or cryogenic cooling. In some embodiments, the methods comprise monitoring and controlling the work piece temperature. In some embodiments, controlling the work piece temperature comprises subjecting the workpiece to active radiation, forced convection, conduction, inductance heating, or a combination thereof. In some embodiments, the methods comprise monitoring and controlling an ambient temperature surrounding the work piece. In some embodiments, the methods comprise monitoring and controlling the wire temperature. In some embodiments, a closed loop control system is employed for automatically controlling one or any combination of steps of the method. In some embodiments, the steps of the method are performed for sequential or simultaneous feature-by-feature manufacturing of a work piece. In some embodiments, the steps of the method are performed for sequential or simultaneous layer-by-layer manufacturing of a work piece. In some embodiments, the method further comprises a step useful to affect grain structure and/or eliminate porosity during solidification. In an embodiment, the method comprises affecting grain structure and/or elimination porosity by grain nucleation. In some cases, a method described herein further includes inserting a secondary wire into melt pool simultaneously or sequentially with a deposition material which is in the form of a primary deposition wire. In some cases, a method described herein further includes insertion of a cored single wire into a melt pool simultaneously or sequentially with a deposition material which is in the form of a primary deposition wire. In some cases, a method described herein further includes insertion of a coated single wire into a melt pool simultaneously or sequentially with a deposition material which is in the form of a primary deposition wire. In embodiments described herein, the coated single wire may be inserted or fabricated by CVD, mechanical wrapping, dipping in melt, painting, rolling, extrusion or any other applicable method known to the skilled artisan. In some embodiments at least one secondary wire comprises a grain refinement alloy wire. In some cases, the grain refinement alloy wire comprises an alloy, wherein the alloy comprises at least one of aluminum, magnesium, zirconium, zinc, scandium, titanium, boron and lithium. In some cases, the grain refinement alloy wire comprises one or more of: aluminum titanium boron (Al—Ti—B) alloy, aluminum titanium carbon (Al—Ti—C) alloy, aluminum niobium boron (Al—Nb—B) alloy, aluminum scandium (Al—Sc) alloy, and aluminum cerium (Al—Ce) alloy. In some instances, the grain refinement alloy wire comprises an aluminum alloy disclosed herein, wherein the aluminum alloy is modified with scandium. In some instances, the grain refinement alloy wire comprises an aluminum alloy disclosed herein, wherein the aluminum alloy is modified with titanium. In some instances, the grain refinement alloy wire comprises an aluminum alloy disclosed herein, wherein the aluminum alloy is modified with boron. In some instances, the grain refinement alloy wire comprises an aluminum alloy disclosed herein, wherein the aluminum alloy is modified with titanium and boron. In some cases a base alloy used in a laser deposition method described herein may comprise Aluminum 1xxx, 2xxx, 3xxx, 4xxx, 5xxx, 6xxx, 7xxx, 8xxx series, one or more aluminum casting alloys and/or a hypereutectic aluminum alloy. Generally, 1xxx series aluminum alloy is at least about 99.00 wt. % aluminum per Aluminum Association standards. Generally, a 2xxx series aluminum alloy comprises copper. Generally, a 3xxx series aluminum alloy comprises manganese. Generally, a 4xxx series aluminum alloy comprises silicon. Generally, a 5xxx series aluminum alloy comprises magnesium. Generally, a 6xxx series aluminum alloy comprises magnesium and silicon. Generally, a 7xxx series aluminum alloy comprises zinc. In some instances, an 8xxx series aluminum alloy comprises lithium. In some instances, an 8xxx series aluminum alloy comprises nickel. In some instances, an 8xxx series aluminum alloy comprises iron. In some embodiments is a method described herein, further comprising at least one coating which is placed on a deposition material which maybe a deposition wire that is ionized with laser during a melt step. In some embodiments, the coating maybe deposited onto wire spool in-situ or on a desired area to be welded ahead of melt pool. In some embodiments, a coating described herein can ionize and emit a more sensitive spectral profile as compared to a method wherein said coating is absent. In some embodiments, the spectral profile is emitted from the depositing wire, melt pool, or base material in the infrared, visible, ultraviolet, or x-ray spectra. In some embodiments, the spectra are measured with high speed hyperspectral imaging system and image data calibrated against known melt pool temperatures, grain solidification behavior, residual stress formation, and dimensional data. In some embodiments image data described herein is used for one or more of real-time quality monitoring and control; and post-build quality verification. In some embodiments, is an alloy or elemental metallic coating on a deposition material which is in the form of a primary deposition wire; or core inserted into a deposition material which is in the form of a primary deposition wire; for hypereutectic alloy creation in-situ of the melt pool during additive processes useful in methods described herein. In some embodiments, a wire feed rate is substantially constant, variable, or both. In some embodiments, a manufacturing method power setting is substantially constant, variable, or both. In some embodiments, a metallic material is added offset from a desired location such that crystallization deformation translates the metallic material to the desired location. In some embodiments, the methods comprise straightening the wire. In some embodiments, the methods comprise straightening wire from a plurality of wire feeds. In some embodiments, the plurality of wire feeds in different directions.

In some aspects, apparatuses disclosed herein comprise a source of a metallic material; a heat source that melts a portion of a work piece surface and the metallic material, wherein the metallic material is being fed into the heat source to form a layer of metallic material on the work piece, a cooler that cools the layer of metallic material to a solidified metallic material; a stress reliever that relieves stress in the added layer; and optionally a secondary machine that removes a portion of the solidified metallic material. In some embodiments, the at least one of the heat source, cooler and stress reliever moves relative to the workpiece. In some embodiments, the at least two of the heat source, cooler and stress reliever are grouped to move together relative to the work piece. In some embodiments, the optional secondary machine performs one or more of drilling, milling, turning, grinding, broaching, reaming, shot peening, grit blasting, polishing, electrical discharge machining and electro-chemical machining. In some embodiments, the stress reliever is applied directly to the added layer. In some embodiments, the stress reliever comprises a pulsed laser to apply laser peening to the added layer. In some embodiments, the stress reliever performs ultrasonic impact treatment. In some embodiments, the stress reliever comprises a high-pressure roller. In some embodiments, the heat source is a laser focused upon the work piece surface and the source of metallic material is a wire delivery device adapted to deliver a metal wire to the focal point of the laser. In some embodiments, the heat source is an electron beam focused upon the work piece surface and the source of the metallic material is a wire delivery device adapted to deliver a metal wire substantially to the focal point of the electron beam. In some embodiments, the cooler comprises a gas cooler. In some embodiments, the cooler comprises cryogenic cooler. In some embodiments, the apparatus comprises an applicator to deposit a sacrificial covering upon an added layer. In some embodiments, the apparatus comprises a monitor and controller of wire temperature prior to the heat source. In some embodiments, the apparatus comprises a monitor and controller of work piece temperature. In some embodiments, the apparatus comprises a monitor and controller of temperature surrounding a work piece. In some embodiments, the apparatus comprises a monitor and controller of module location with reference to a work piece. In some embodiments, the apparatus comprises a monitor of temperature surrounding a work piece. In some embodiments, the apparatus comprises a monitor of ambient temperature surrounding a work piece. In some embodiments, the apparatus comprises a controller of temperature surrounding a work piece. In some embodiments, the apparatus comprises a controller of ambient temperature surrounding a work piece. In some embodiments, the apparatus comprises a monitor and controller of temperature surrounding a work piece. In some embodiments, the apparatus comprises a monitor and controller of ambient temperature surrounding a work piece. In some embodiments, the apparatus includes a monitor of module location with reference to a work piece. In some embodiments, the apparatus includes a controller of module location with reference to a work piece. In some embodiments, the apparatus includes a monitor and controller of module location with reference to a work piece. In some embodiments, the apparatus includes a monitoring real time location and temperature conditions of a surface of a work piece. In some embodiments, said work piece comprises at least one integrated element deposited thereon. In some embodiments, the integrated element is a fuel line. In some embodiments, the integrated element is a fuel injector.

In some aspects, methods disclosed herein comprise at least one of in-situ laser scraping, mechanical scraping, peening or passivation cleaning of at least one of: the portion of the work piece for deposition, the weld wire to remove oxides, hydrocarbons, soot, water, and particulate. In some embodiments is a method described herein, comprising near real-time modification of the deposition path and build parameter commands based on previously-built section of print. In some embodiments, the method comprises modifications including for instance allocation for component warping, process parameter variations, gradient material properties, and as-built component reconstruction based on melt pool sensor feedback.

In some aspects, methods of additive manufacture disclosed herein comprise in process control by quantitative optical tomography. In some embodiments are artificial intelligence control system, neural network control system, deep learning control system, and control systems using relationship between multiple sensors' data to intuit new data insight and affect the control of the additive manufacturing system. In some embodiments, is a method of manufacturing a shell-like structural component for a vehicle using additive layer manufacturing, comprising: applying a first material to a region of the shell-like structural component in a deposition pattern that enables selective compliance of the structure through anisotropic material properties. In some embodiments, the method described herein comprises a deposition pattern providing more compliance in the interlayer direction than the layerwise direction. In some embodiments, the method further comprises controlling at least one of: layer orientation, deposition direction, melt pool width, melt pool thickness, grain solidification, heat input, and alloy gradient. In some embodiments, the shell-like structural component comprises desired properties and/or selective compliance allowing for at least one of deterministic load pathways, optimized structural mass, properties, safety, and reliability.

In some aspects, methods disclosed herein for manufacturing a shell-like structural component using additive layer manufacturing, comprise: applying a first material to a region of the shell-like structural component; heating the region of the shell-like structural component such that the first material is added to the shell-like structural component; and cooling the shell-like structural component comprising the first material, such that an internal stress is generated within the shell-like structural component resulting in the selective pre-tensioning or pre-compressing of the shell-like structural component. In some embodiments, the selective pre-tensioning or pre-compressing does not result in substantial bending. In some embodiments, the selective pre-tensioning or pre-compressing results in less than 1%, 2%, 3%, 4%, 5%, 6% or 7% bending of the structural component. In some embodiments, the heating comprises contact with at least one laser beam.

In some aspects, methods disclosed herein for manufacturing an injector for combustion of a first and a second propellant using additive layer manufacturing, comprise: applying a first material to a region of a first, central injection channel connectable to a first propellant supply for a first propellant; heating the region of the first central injection channel by a laser beam such that the first material is added to the first, central injection channel; cooling the first central injection channel comprising the first material; applying a second material to a region of a second injection channel being connectable to a second propellant supply for a second propellant; heating the region of the second injection channel by a laser beam such that the second material is added to the second, central injection channel; and cooling the second injection channel comprising the second material. In some embodiments, the first and second materials are different. In some embodiments, the first and second materials are the same. In some embodiments, the second injection channel annularly surrounds the first injection channel, and wherein the second injection channel widens in a region of a downstream opening. In some embodiments, at least one of said first and second propellant comprises liquid oxygen. In some embodiments, at least one of said first and second propellant comprises a working fluid that undergoes a phase change. In some embodiments, the injector comprises at least one baffled element. In some embodiments, the injector comprises a plurality of baffled elements. In some embodiments, the methods comprise applying an additional material to a region of the injector; heating the region of the injector by a laser beam such that the material is added to the injector; and cooling the injector comprising the additional material, to form an injector comprising at least one integrated baffled element. In some embodiments, at least one of said first material, second material and an additional material comprises Ni or an alloy thereof. In some embodiments, at least one of said first material, second material and additional material comprises Ni or an alloy thereof. In some embodiments, said work piece is a payload launch vehicle. In some embodiments, said work piece comprises at least one integrated element deposited thereon. In some embodiments, the integrated element is a fuel line. In some embodiments, the integrated element is a fuel injector.

In some aspects, apparatuses disclosed herein are configured to supply a first propellant from a propellant storage to a rocket engine of a launch vehicle, comprising: an impeller comprising a motor and an impeller, the impeller being configured to continuously drive the first propellant from the propellant storage through a supply line towards the rocket engine during a launching time period in which the launch vehicle is launched away from Earth; a heat exchanger configured to heat the first propellant to provide a first heated propellant; an electrical generator comprising an (1) electricity generator and a (2) gas turbine configured to receive the heated propellant, the gas turbine comprising: a first turbine shaft, and a second turbine shaft, wherein the first and the second turbine shafts are configured to rotate independently of one another in response to flow of the heated propellant through the gas turbine, wherein the first turbine shaft is mechanically coupled to a motor shaft of the impeller for transferring rotation of the first turbine shaft to the motor shaft of the impeller for transferring mechanical energy from the gas turbine to the motor shaft for driving the impeller, and wherein the second turbine shaft is mechanically coupled to a generator shaft of the electricity generator for generating electrical power, the electricity generator being configured to generate electrical power at a rate independent of a rate at which the mechanical energy is transferred from the gas turbine to the motor shaft; and an electrical energy storage configured to store electricity generated by the electricity generator to power at least one of the impeller and a second impeller configured for continuously driving a second propellant towards the rocket engine. In some embodiments, the motor and the electrical generator are a single unit. In some embodiments, the motor and the electrical generator are separate units. In some embodiments, the apparatus comprises an electrical energy storage bypass. In some embodiments, the first heated propellant is in a supercritical phase. In some embodiments, the heat exchanger comprises a regenerative cooling channel on at least a portion of the rocket engine. In some embodiments, the regenerative cooling channel is located on at least one of a portion of an outer surface of the combustion chamber and an outer surface of a nozzle of the rocket engine. In some embodiments, the apparatus comprises a supply line from the propellant storage to the motor of the impeller for supplying the first propellant to the motor to cryogenically cool the motor of the impeller. In some embodiments, the first propellant comprises a fuel. In some embodiments, the first propellant is a working fluid that undergoes a phase change. In some embodiments, the second propellant comprises an oxidant. In some embodiments, the second propellant is liquid oxygen. In some embodiments, the impeller and the second impeller are configured to provide a liquid fuel and a liquid oxidant into the rocket engine at a volumetric ratio of about 5:1 to a volumetric ratio of about 0.2:1. In some embodiments, the motor of the impeller comprise an electrical motor. In some embodiments, the motor comprises a variable reluctance motor. In some embodiments, the motor comprises a brushless DC motor. In some embodiments, the motor comprises an AC induction motor. In some embodiments, the energy storage comprises at least one of a battery and a supercapacitor. In some embodiments, the impeller is configured to inject the first propellant into at least one of a combustion chamber and a nozzle of the rocket engine. In some embodiments, the impeller is configured to impel at least a portion of a first propellant supply from the propellant storage directly into at least one of the rocket engine and the heat exchanger. In some embodiments, all of the first propellant supply is impelled directly into the heat exchanger. In some embodiments, the apparatus is configured to supply at least a portion of the first heated propellant exiting the heat exchanger to the rocket engine without routing the first heated propellant through the electrical generator or the turbine. In some embodiments, the apparatus is configured to supply at least a portion of the first heated propellant exiting the heat exchanger to the rocket engine without routing the first heated propellant through the turbine. In some embodiments, the impeller is configured to impel a quantity of the first propellant through the heat exchanger and the electrical generator so as to generate at least 10 kilowatts of power during a thrusting time period. In some embodiments, the impeller is configured to impel a quantity of the first propellant through the heat exchanger and the electrical generator to provide a high power output continuously for a period of at least 60 seconds. In some embodiments, the impeller is configured to impel a quantity of the first propellant through the heat exchanger and the electrical generator to provide a high power output continuously for a period of about 60 to about 400 seconds. In some embodiments, the apparatus is configured to supply at least one of mechanical energy from rotation of the first turbine shaft and electrical energy from the electrical energy storage sufficient to drive the impeller to provide a quantity of the first propellant into the rocket engine during the launching period for providing a thrust of about 5,000 lbf to about 150,000 lbf. In some embodiments, the apparatus is configured to supply at least one of mechanical energy from rotation of the first turbine shaft and electrical energy from the electrical energy storage sufficient to drive the impeller to provide a quantity of the first propellant into the rocket engine during the launching period for providing a thrust of at least about 3,000 lbf.

In some aspects, methods disclosed herein for supplying a first propellant from a propellant storage to a rocket engine of a launch vehicle, comprise: supplying the first propellant from the propellant storage to an impeller, the impeller comprising a motor and an impeller configured to be driven by the motor, and to propel the first propellant towards the rocket engine during launch of the launch vehicle away from Earth; propelling at least a portion of the first propellant from the impeller to a heat exchanger; heating the first propellant in the heat exchanger to provide a heated first propellant; supplying the heated first propellant to an electrical generator, the electrical generator comprising a gas turbine configured to independently rotate a first turbine shaft and a second turbine shaft in response to flow of the heated first propellant through the gas turbine; rotating a motor shaft of the motor coupled to the first turbine shaft; rotating a generator shaft of the electrical generator coupled to the second turbine shaft, and generating electricity in response to the flow of the first heated propellant through the gas turbine; storing electricity generated by the electrical generator in an electrical energy storage; and discharging the electrical energy storage to power a second impeller configured to impel a second propellant to the rocket engine during launch of the launch vehicle away from Earth. In some embodiments, heating the first propellant in the heat exchanger comprises heating the first propellant to a supercritical phase. In some embodiments, the methods further comprise flowing the first propellant to the motor of the impeller from the propellant storage to cryogenically cool the motor. In some embodiments, heating the first propellant in the heat exchanger comprises supplying the first propellant through regenerative cooling channels on at least a portion of an outer surface of the rocket engine. In some embodiments, the methods comprise supplying at least a portion of the first propellant exiting from the electrical generator to the propellant storage for autogenous pressurization. In some embodiments, the methods comprise dumping overboard at least a portion of the first propellant exiting from the electrical generator. In some embodiments, the methods comprise supplying at least a portion of the first propellant exiting from the electrical generator to the rocket engine. In some embodiments, the methods comprise impelling the first propellant into a combustion chamber of the rocket engine. In some embodiments, the methods comprise impelling a second propellant into a combustion chamber of the rocket engine. In some embodiments, the methods comprise supplying all of the first propellant exiting from the electrical generator to the rocket engine. In some embodiments, the methods comprise supplying at least a portion of the heated first propellant exiting the heat exchanger to the rocket engine. In some embodiments, the methods comprise propelling at least a portion of the first propellant from the impeller to the rocket engine. In some embodiments, said work piece is a payload launch vehicle. In some embodiments, the integrated element is a propellant line. In some embodiments, the integrated element is a propellant injector.

In some aspects, methods disclosed herein for manufacturing a shell-like structural component for a vehicle using additive layer manufacturing, comprise applying a first material to a region of the shell-like structural component in a deposition pattern. In some embodiments, applying a first material to a region of the shell-like structural component in a deposition pattern enables selective compliance of said structural component through material properties. In some embodiments, the methods comprise providing a deposition pattern with more compliance in an interlayer direction than a layerwise direction. In some embodiments, the methods comprise providing a deposition pattern with less compliance in an interlayer direction than a layerwise direction. In some embodiments, the methods comprise controlling at least one of: layer orientation, deposition direction, melt pool width, melt pool thickness, solidification, heat input, layer width, layer thickness, and alloy gradient. In some embodiments, the methods are configured to provide a shell-like structural component comprising desired properties and/or selective compliance allowing for at least one of deterministic load pathways, optimized structural mass, properties, safety, and reliability.

In some aspects, methods disclosed herein for manufacturing a shell-like structural component for a vehicle using additive layer manufacturing, comprise: applying a first material to a region of the shell-like structural component; heating the region of the shell-like structural component such that the first material is added to the shell-like structural component; and cooling the shell-like structural component comprising the first material, such that an internal stress is generated within the shell-like structural component resulting in a selective pre-tensioning or pre-compressing of the shell-like structural component. In some embodiments, the heating comprises contact with at least one laser beam or electron beam. In some embodiments, the methods comprise a cleaning step which comprises at least one of in-situ laser scraping, mechanical scraping, peening, degreasing, heating, vacuum dehumidifying, desiccating, electropolishing, and passivation cleaning of said work piece. In some embodiments, the cleaning step comprises in-situ laser scraping, mechanical scraping, peening, degreasing, heating, vacuum dehumidifying, desiccating, electropolishing, or passivation cleaning of at least one of: said work piece, and a wire. In some embodiments, the methods comprise near real-time modifying of a deposition path and a build parameter command based on a previously-built section of said work piece. In some embodiments, the near-real time modifying comprising at least one of: allocating for component warping, processing a parameter variation, a gradient material property, and as-built component reconstruction. In some embodiments, said near-real time modifying is in response to melt pool sensor feedback. In some embodiments, the methods comprise performing grain nucleation to substantially reduce grain porosity, as compared to a corresponding method absent grain nucleation. In some embodiments, said grain porosity is reduced by at least about: 1%, 2%, 3%, 4%, 5%, 6%, 7%, 8%, 10%, 15%, 20%, 25%, 30%, 35%, 40%, 45%, 50%, 55%, 60%, 65%, 70%, 75%, 80%, 85%, 90%, 95%, 99%, 99.9% or 100%. In some embodiments, said deposition material is in the form of a primary deposition wire, said method further comprising inserting a secondary wire into a melt pool simultaneously or sequentially with said primary deposition wire. In some embodiments, said deposition material is in the form of a primary deposition wire, said method further comprising insertion of a cored single wire into a melt pool simultaneously or sequentially with said primary deposition wire. In some embodiments, deposition material is in the form of a primary deposition wire, said method further comprising insertion of a coated single wire into a melt pool simultaneously or sequentially with said primary deposition wire. In some embodiments, said coated single wire is fabricated by chemical vapor deposition (CVD), mechanical wrapping, dipping in melt, painting, rolling, or extrusion. In some embodiments, the methods comprise depositing a secondary material, wherein the secondary material is in the form of a secondary wire, and wherein the secondary wire comprises a grain refinement alloy wire. In some embodiments, said grain refinement alloy wire comprises at least one of: aluminum titanium boron (Al—Ti—B) alloy, aluminum titanium carbon (Al—Ti—C) alloy, aluminum niobium boron (Al—Nb—B) alloy, aluminum scandium (Al—Sc) alloy, and aluminum cerium (Al—Ce) alloy. In some embodiments, said deposition material comprises a metal alloy, wherein the metal alloy comprises at least one element selected from aluminum, magnesium, scandium, cerium, zinc, zirconium, lithium, titanium, boron, and copper. In some embodiments, said secondary material comprises a metal alloy, wherein the metal alloy comprises at least one element selected from aluminum, magnesium, scandium, cerium, zinc, zirconium, lithium, titanium, boron, and copper. In some embodiments, said deposition material is in the form of a primary deposition wire, wherein the primary deposition wire comprises at least one coating which is placed on said deposition wire. In some embodiments, said coating is ionized by heating with a laser. In some embodiments, said coating emits a more sensitive spectral profile upon being ionized as compared to a method wherein said coating is absent.

In some aspects, apparatuses disclosed herein are configured to supply a first propellant from a propellant storage to a launch vehicle rocket engine of a launch vehicle, comprising: an impeller comprising a motor and a pumping, the pump being configured to continuously drive the first propellant from the propellant storage through a supply line towards the rocket engine during a launching time period in which the launch vehicle is launched away from Earth; a gas generator or pre-burner configured to combust the first propellant to provide a first heated working fluid; an electrical generator comprising an (1) electricity generator and a (2) gas turbine configured to receive the first heated working fluid, the gas turbine comprising: a first turbine shaft, and a second turbine shaft, wherein the first and the second turbine shafts are configured to rotate independently of one another in response to flow of the first heated working fluid through the gas turbine, wherein the first turbine shaft is mechanically coupled to a motor shaft of the impeller for transferring rotation of the first turbine shaft to the motor shaft of the impeller for transferring mechanical energy from the gas turbine to the motor shaft for driving the impeller, and wherein the second turbine shaft is mechanically coupled to a generator shaft of the electricity generator for generating electrical power, the electricity generator being configured to generate electrical power at a rate independent of a rate at which the mechanical energy is transferred from the gas turbine to the motor shaft; and an electrical energy storage configured to store electricity generated by the electricity generator to power at least one of the impeller and a second impeller configured for continuously driving a second propellant towards the rocket engine.

In some aspects, methods disclosed herein for supplying a first propellant from a propellant storage to a rocket engine of a launch vehicle, comprise: supplying a first propellant from the propellant storage to an impeller, the impeller comprising a motor and an impeller configured to be driven by the motor, and to propel the first propellant towards the rocket engine during launch of the launch vehicle away from Earth; propelling at least a portion of the first propellant from the impeller to a gas generator or pre-burner; combusting the first propellant in the gas generator or pre-burner to provide a first heated working fluid; supplying the heated working fluid to an electrical generator, the electrical generator comprising a gas turbine configured to independently rotate a first turbine shaft and a second turbine shaft in response to flow of the first heated working fluid through the gas turbine; rotating a motor shaft of the motor coupled to the first turbine shaft; rotating a generator shaft of an electricity generator coupled to the second turbine shaft, and generating electricity in response to the flow of the first heated working fluid through the gas turbine; storing electricity generated by the electricity generator in an electrical energy storage; and discharging the electrical energy storage to power a second impeller configured to impel a second propellant to the rocket engine during launch of the launch vehicle away from Earth.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a flowchart describing an example method for manufacturing a work piece.

FIG. 2 is a flowchart describing an example method for manufacturing a work piece.

FIG. 3 is a flowchart describing an example method for manufacturing a work piece using ALM.

FIG. 4 is a schematic view of an example ALM apparatus for manufacturing a work piece.

FIG. 5 is a schematic diagram of an example set-up for a print head layer deposition process, according to some embodiments.

FIG. 6 is a photograph of an example set-up for a print head layer deposition process.

FIG. 7 is a photograph of an example of a laser wire deposition of aluminum 5556 alloy.

FIG. 8 is a schematic diagram of an architectural model for an additive manufacturing cell.

FIG. 9 is a photo showing an example of a TRL Level 5 Demonstrator in factory environment.

FIG. 10 is a photograph of an example of a robotic arm configured for aluminum 3-D printing.

FIG. 11 is a photograph of an example of a custom metal deposition head. This metal deposition head can demonstrate printing at up to about 5 lbm/hr.

FIG. 12 is a micrograph of 5083 aluminum laser deposition demonstrating >99.95% density.

FIG. 13 is an aluminum robotic additive cell demonstrating switching polarity, pulsed metal inert gas (MIG) deposition.

FIG. 14 is a process diagram of an example of an automated process for manufacturing small payload launch vehicles. The process can include real-time meltpool feedback and database of telemetry. This process may be amenable to planned intelligent deposition upgrades for Stargate V2, including machine learning, neural networks, and sophisticated in-situ non-destructive testing (NDT).

FIG. 15 is a schematic diagram of an example of a liquid propellant supply system with a single propellant assembly, according to some embodiments.

FIG. 16 is a schematic diagram of an example of a liquid propellant supply system, with a multi-propellant assembly according to some embodiments.

FIG. 17 is a schematic diagram of an example of a liquid propellant supply system, with a common motor/turbine shaft, according to some embodiments.

FIG. 18 is a schematic diagram of an example of a liquid propellant supply system, with optional direct energy flow between motors, according to some embodiments.

FIG. 19 is a schematic diagram of an example of a liquid propellant supply system, with optional direct energy flow between motors and a common motor/turbine shaft, according to some embodiments.

FIG. 20 is a schematic diagram of an example of a liquid propellant supply system, wherein a first motor powers an impeller shaft, according to some embodiments.

FIG. 21 is a schematic diagram of an example of a liquid propellant supply system, wherein a first motor powers an impeller/turbine shaft, according to some embodiments.

FIG. 22 is a schematic diagram of an example of a liquid propellant supply system with an optional battery bypass, wherein a first motor powers an impeller shaft, according to some embodiments.

FIG. 23 is a schematic diagram of an example of a liquid propellant supply system with an optional battery bypass, wherein a first motor powers an impeller/turbine shaft, according to some embodiments.

FIG. 24 is a schematic diagram of an example of a liquid propellant supply system, wherein a turbine is connected to an impeller/motor shaft that spins the motor/generator, according to some embodiments.

FIG. 25 is a schematic diagram of an example of a liquid propellant supply system, wherein the system allows a portion of a propellant to be burned off or re-directed elsewhere, according to some embodiments.

FIG. 26 is a schematic diagram of an example of a liquid propellant supply system, according to some embodiments.

FIG. 27 is a schematic diagram of an example of a liquid propellant supply system, according to some embodiments.

### DETAILED DESCRIPTION

While some embodiments have been shown and described herein, it will be obvious to those skilled in the art that such embodiments are provided by way of example only. Numerous variations, changes, and substitutions will now occur to those skilled in the art without departing from the invention. It should be understood that various alternatives to these embodiments described herein may be employed in practicing the invention.

### Additive Layer Manufacturing

In some aspects, this disclosure describes an additive layer manufacturing (ALM) process for manufacturing components, for example, using laser wire manufacturing, electron beam wire manufacturing, and/or other types of ALM processing. In some instances, the ALM process includes secondary processes integrated into the main ALM manufacturing. Secondary processes can include relieving stress in the component (e.g., peening a surface of the component, heating/cooling steps, thermal control of the component, monitoring the component, and/or other secondary steps). In some conventional ALM processes, secondary options described herein are not able to be combined into the main ALM manufacturing processes, for example, due to risk of damaging the component, spatial arrangement of the manufacturing components (e.g., crowding a workspace of the component), and/or other. For example, some conventional ALM processes require a separate operation for heating and depositing material, cooling a material, stress-relieving a material, and manufacturing a material, where a subset of these steps can require total completion before moving on to a subsequent step (e.g., complete cooling of an entire component before subsequent laser peening and/or machining operations). In some implementations of the present disclosure, the main ALM processes and the secondary processes can be performed simultaneously, e.g., continuously during manufacturing of a component, so that the manufacturing process of a component is not needed to be segmented into multiple steps. For example, being able to combine steps of heating and depositing material, cooling the material, stress-relieving the material, and/or manufacturing the material into a substantially continuous process allows for a more efficient and time-saving manufacturing process.

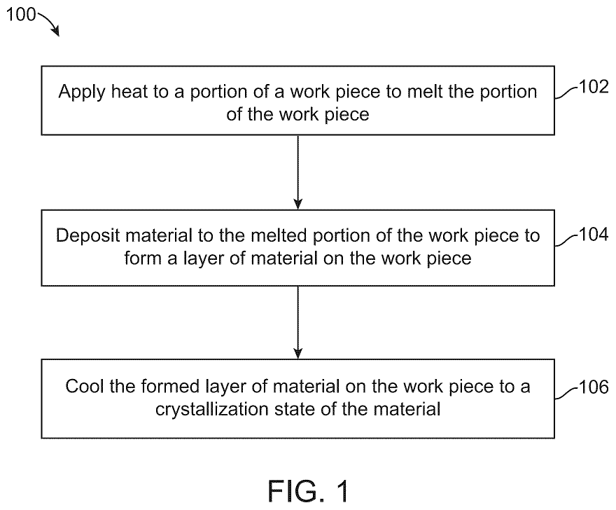

In some instances, the main ALM manufacturing process includes applying heat to a portion of a work piece to melt the portion of the work piece, depositing material to the melted portion of the work piece to form a layer of material on the work piece, and cooling the formed layer of material on the work piece to a crystallization state of the material. For example, FIG. 1 is a flowchart describing an example ALM method 100 for manufacturing a component. At 102, heat is applied to a portion of a work piece to melt the portion of the work piece. At 104, material is deposited to the melted portion of the work piece to form a layer of the material on the work piece. At 106, the formed layer of material on the work piece is cooled to a crystallization state of the material. Additional secondary processes can be performed simultaneously with or subsequent to the main ALM manufacturing process (e.g., steps 102 and 103, and/or steps 102-104), for example, peening, cooling, and/or machining the work piece into a desired resulting component. In some examples, the present disclosure describes the manufacture of components for an orbital vehicle, launch vehicle, automobile, and/or other component or vehicle intended for use outside of Earth's atmosphere.

In some instances in the laser wire process, during deposition of the initial layer(s), the laser beam is directed at a piece of starting material or “parent plate” to create a weld pool in the parent plate to which the wire is added. The wire is carried to the focal point of the laser. It can be a problem with some conventional types of manufacturing that, during weld pool creation, the work piece is subject to intense localized heating. This heating creates steep thermal gradients in the work piece between the molten material in the weld pool and cold material which surrounds it. If transverse compressive stresses in the work piece, which are caused by very hot expanding material, exceed the yield point of the material then compressive plastic yielding (CPY) can occur in the material surrounding the weld. On cooling and shrinkage of the work piece, high tensile residual transverse stresses can be created across the weld and these will be balanced by residual compressive stresses further away from the weld. It is these residual compressive stresses which can cause buckling distortion, for example, when they exceed a critical buckling load (CBL) for the parent material of the work piece. This is a particular difficulty when working with thin section material. The conventional Electron Beam process can include the same intense local heating problems.

In some implementations, during cooling of the work piece, the solidification rate of the material can be a determining factor for the final microstructure of the work piece. In some examples, the microstructure of the material can play an essential role in controlling mechanical properties of a material or work piece. For example, microstructure morphologies which have been observed with conventional ALM methods commonly show large columnar grains growing vertically from bottom to top of the work piece build. This type of grain structure produces mechanical properties which can be unfavorable compared to fine grained equi-axed structures and those of wrought material. It is accordingly an aim of the present disclosure to overcome at least some of the difficulties with some conventional ALM methods.

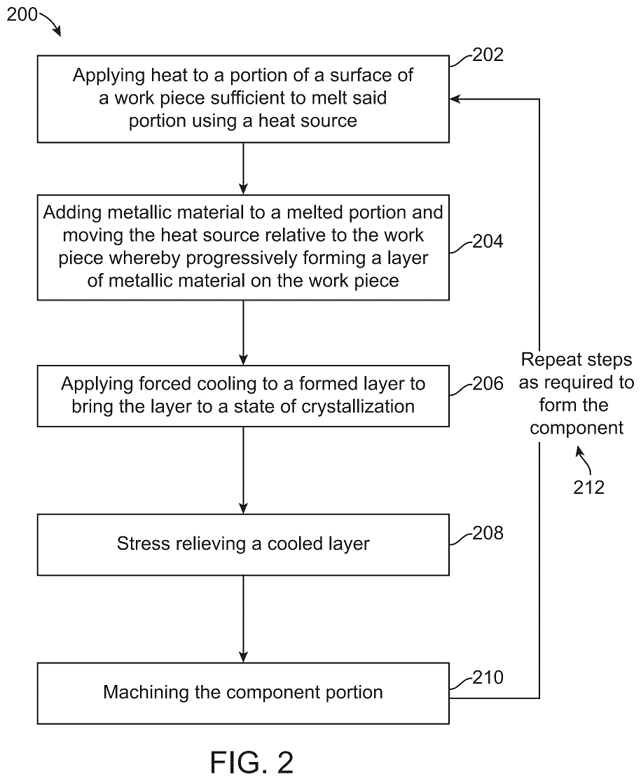

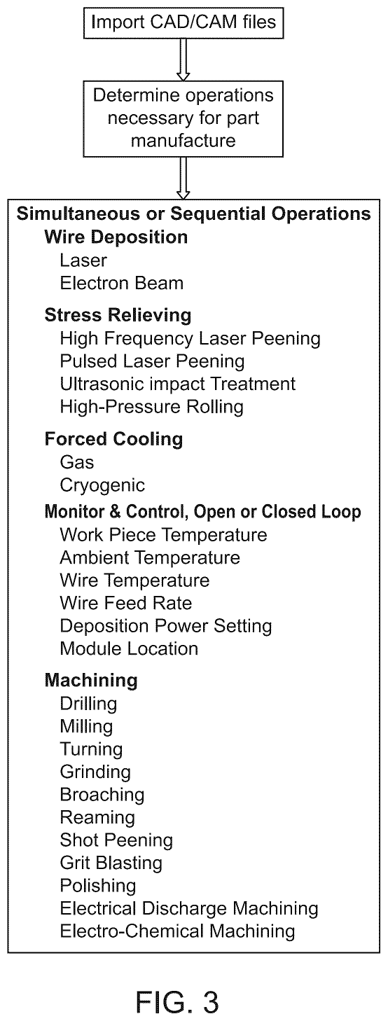

FIG. 2 is a flowchart describing an example method 200 for manufacturing a work piece according to the present disclosure. For example, the example method 100 can include forming a metallic component by additive layer manufacturing. For example, at 202, heat is applied to a portion of a surface of a work piece sufficient to melt said portion. At 204, metallic material is added to the melted portion and the heat source is moved relative to the work piece to progressively to form a layer of metallic material on the work piece. At 206, forced cooling is applied to the formed layer to bring the layer to a state of crystallization. At 208, the cooled layer is stress-relieved, for example, through a stress-relieving operation. At 210, the component portion is machined (e.g., via machining operations). The method 200 shows that, at 212, one or more or all of steps 202 to 210 can be repeated to form the component. The disclosure provides a method of mitigating distortion for each layer during the building of additive layer manufactured parts, and a method for machining manufactured parts during the additive process. Not only is distortion controlled, but the internal microstructure of the final part can be refined, thereby improving mechanical properties. The manufacturing steps can be performed in any order, sequentially or simultaneously.

The additive manufacturing method can vary. For example, the additive manufacturing method can include laser wire manufacture, electron beam wire manufacture, and/or another additive manufacturing process.

The step of stress relieving the layer can vary. For example, stress relieving the layer can include applying high frequency peening to the layer, for example, which can include applying pulsed laser treatment, ultra-sonic impact treatment, and/or other peening process to a surface of the layer. In some examples, the step of applying pulsed laser treatment to the surface of the layer can include applying a covering to the surface whereby to focus a shock wave generated by each laser pulse into the layer. The covering may be a sacrificial layer such as a coating or tape and/or a liquid covering, and/or other layer. The covering may prevent or inhibit melting a portion of the workpiece that is not a portion of the workpiece that is subjected to the laser pulse. The covering may prevent or inhibit melting a portion of the workpiece that is proximal to a portion of the workpiece that is subjected to the laser pulse.

In some instances, the additive manufacturing process can include monitoring or control of the work piece temperature, ambient temperature, wire temperature, and/or other temperature variables of the work piece or surrounding the work piece. In certain instances, the additive manufacturing method can include constant or variable power settings.

The additive manufacturing method deposition locations can vary. For example, the deposition locations can purposefully differ from intended material locations, for example, to account for material deformation during the cooling process.

In some implementations, an apparatus configured to perform the additive layer manufacturing of a component (e.g., metallic, plastic, and/or other component) is provided. For example, the apparatus can include modules that can move relative to a work piece. In some instances, the module can be defined as a mobile apparatus located through robotic movements. The module types can vary, and can include: a heat source and a source of metallic material, cooler, stress reliever (e.g., peening apparatus), secondary machine (e.g., drilling; milling; turning; grinding; broaching; reaming; shot peening; grit blasting; polishing; electrical discharge machining; and electro-chemical machining.) The example heat source is sufficient to melt a portion of a surface of the work piece together with, for example, metallic material being fed into the heat source to form an added layer of metallic material on the work piece. The example cooler can be configured to cool the added layer to a state of crystallization. The example stress reliever can be configured to relieve stress in the added layer, for example, by peening. The example secondary machine can be configured to remove a portion of component material, for example, to form at least a portion of a completed component.

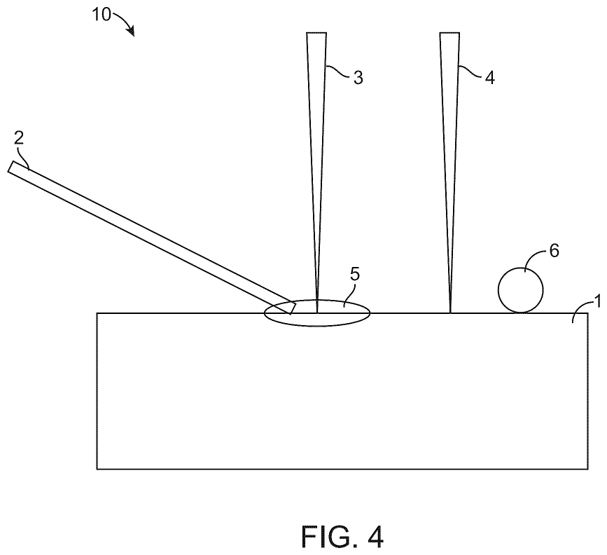

FIG. 4 shows is a schematic view of an example apparatus 10 configured to manufacturing a work piece using ALM. The example apparatus 10 includes a heat source 3 focused substantially onto a work piece 1. A melt-pool 5 is created via the heat source 3 focusing on the work piece 1. A feed wire 2 is directed into the melt-pool 5, and a stress-relief source 4, located just offset from the melt-pool 5, is simultaneously applied to the work piece 1. In some instances, the heat source 3 and feed wire 2 moves along a surface of the work piece 1 to add successive layers to the work piece 1, and the stress-relief source 4 can follow immediately behind, adjacent to, or otherwise slightly offset from the melt-pool 5. The location of the stress-relief source 4 can vary. The example apparatus also includes a roller element 6 substantially following the stress-relief source 4. Although not shown in the example apparatus 10 of FIG. 4, additional modules and respective components of the additional modules can be included in the apparatus 10. For example, a cooler, sensors, machining components, and/or other components can be located substantially adjacent to the melt-pool 5 and/or the stress-relief source 4 at the surface of the work piece 1 to apply secondary operations to the work piece 1.

Various modules (e.g., robotic components) can be combined together such that they are moved together relative to a work piece.

The secondary machine can vary, for example, between a plethora of machining methods. For example, the secondary machine can include drilling, milling, turning, grinding, broaching, reaming, shot peening, grit blasting, polishing, electrical discharge machining and electro-chemical machining. One or more modules can include a drill, mill, a rotating hand, grinder, reamer, peening component, blaster, polisher, and/or other machining components to effect machining of the component. These machining operations can be performed simultaneously with, or sequentially to, the heating, depositing, and or cooling processes described above. In some examples, removal of material sequentially or simultaneously to other operations can fully or partially remove the need for machining after the additive process is complete.

In some implementations, the stress relieving process can be applied specifically to the added layer and can thus modify the microstructure of the added layer. The stress relieving process can take many forms, for example, such as a pulsed laser to apply laser peening to the added layer, ultrasonic impact treatment (UIT), and/or other peening operations. These example treatments include the application of small amounts of force at high frequency to the work piece surface to work harden the applied layer of material (e.g., metallic material). In some implementations, the stress reliving process can include high pressure rolling.

In certain instances where a pulsed laser is used to achieve the stress relief, the apparatus can include a module to assist the focus of each laser pulse into the cooled added layer. The example module can deposit a sacrificial covering upon the cooled layer and can be adapted to deposit a layer of paint, tape, and/or a liquid layer. In some examples, the heat source can include a laser focused upon the work piece surface and the source of metallic material can be a powder and gas delivery device adapted to deliver gas carrying the metal powder substantially to the focal point of the laser.

The cooling can vary. For example, the cooling can include forced gas cooling, water spray cooling, cryogenic cooling, and/or other types of cooling.

In some instances, the apparatus includes monitoring real time location and temperature conditions of a surface of a work piece, for example, using a controller, camera, sensors, and/or other devices (e.g., eddy current probe, thermal camera, proximity sensor, variable reluctance sensor, computer vision, x-ray scanning, dial indicator) and/or other. In some examples, monitoring these conditions can include monitoring for closed loop control of module locations.

Some aspects encompass a method including applying heat to a portion of a work piece to melt the portion of the work piece, depositing material to the melted portion of the work piece to form a layer of material on the work piece, and cooling the formed layer of material on the work piece to a crystallization state of the material.

The aspects above can include some, none, or all of the following features. The method can include moving a heat source of the heat relative to the work piece to continuously melt portions of the work piece, continuously depositing material to the melted portions of the work piece to form a continuous layer of the material on the work piece, and, in response to continuously depositing the material to the melted portions of the work piece, continuously cooling the continuous layer of the material on the work piece. Continuously cooling the continuous layer can include continuously cooling the portion of the continuous layer immediately adjacent to the deposited portion of the continuous layer. The continuous cooling can occur simultaneously with the continuous depositing. The method can include stress relieving the cooled layer of the work piece. The method can include machining the work piece to form a component. The component can include a structural component of an orbital vehicle or launch vehicle

In some embodiments, is a method described herein, further comprising a step useful to affect grain structure and/or eliminate porosity during solidification. In an embodiment, the method comprises affecting grain structure and/or elimination porosity by grain nucleation. In some cases, a method described herein further includes inserting a secondary wire into melt pool simultaneously or sequentially with a deposition material which is in the form of a primary deposition wire. In some cases, a method described herein further includes insertion of a cored single wire into a melt pool simultaneously or sequentially with a deposition material which is in the form of a primary deposition wire. In some cases, a method described herein further includes insertion of a coated single wire into a melt pool simultaneously or sequentially with a deposition material which is in the form of a primary deposition wire. In embodiments described herein, the coated single wire may be inserted or fabricated by CVD, mechanical wrapping, dipping in melt, painting, rolling, extrusion or any other applicable method known to the skilled artisan. In some embodiments at least one secondary wire comprises a grain refinement alloy wire. In some cases, the grain refinement alloy wire comprises an alloy, wherein the alloy comprises at least one of aluminum, magnesium, zirconium, zinc, scandium, titanium, boron and lithium. In some cases, the grain refinement alloy wire may comprise one or more of: aluminum titanium boron (Al—Ti—B) alloy, aluminum titanium carbon (Al—Ti—C) alloy, aluminum niobium boron (Al—Nb—B) alloy. In some cases a base alloy used in a laser deposition method described herein may comprise Aluminum 1xxx, 2xxx, 3xxx, 4xxx, 5xxx, 6xxx, 7xxx, 8xxx series, one or more aluminum casting alloys and/or a hypereutectic aluminum alloy.

In some embodiments is a method described herein, further comprising at least one coating which is placed on a deposition material which maybe a deposition wire that is ionized with laser during a melt step. In some embodiments, the coating maybe deposited onto wire spool in-situ or on a desired area to be welded ahead of melt pool. In some embodiments, a coating described herein can ionize and emit a more sensitive spectral profile as compared to a method wherein said coating is absent. In some embodiments, the spectral profile is emitted from the depositing wire, melt pool, or base material in the infrared, visible, ultraviolet, or x-ray spectra. In some embodiments, the spectra are measured with high speed hyperspectral imaging system and image data calibrated against known melt pool temperatures, grain solidification behavior, residual stress formation, and dimensional data. In some embodiments image data described herein is used for one or more of real-time quality monitoring and control; and post-build quality verification.

In some embodiments, the primary deposition wire comprises a coating. In some embodiments, the coating comprises a secondary elemental metal or a secondary alloy. In some embodiments, is an alloy or elemental metallic coating on a deposition material which is in the form of a primary deposition wire. In some embodiments, is an alloy or elemental metallic coating on a deposition material which is in the form of a core, wherein the core is fabricated or inserted into a deposition material which is in the form of a primary deposition wire. In some embodiments, methods disclosed herein comprise depositing a coating on an exterior surface of the primary deposition wire, wherein the coating comprises a second metallic alloy or second elemental metal. In some embodiments, depositing comprises at least one of the methods selected from: electroplating, chemical vapor deposition, drawing, thermal spraying, or wrapping. In some embodiments, the primary deposition wire is used for producing a hypereutectic alloy of the melt pool in-situ during additive processes of methods described herein.

In some embodiments, methods disclosed herein comprise straightening deposition wire. Deposition wires are described herein. In some instances, the methods comprise straightening a primary deposition wire. In some instances, the methods comprise straightening a secondary deposition wire. In some instances, the methods comprise straightening a primary deposition wire and a secondary deposition wire. In some instances, the methods comprise use of a wire straightening device disclosed herein. In some instances, the methods comprise feeding the wire through a roller. In some instances, the methods comprise feeding the wire from multiple directions. In some cases, straightening the wire comprises heating the wire. Heating the wire may include subjecting the wire to at least one of the following: electric resistive heating, inductive heating, radiative heating, conduction heating, and convective heating.

In some embodiments, methods disclosed herein comprise steps aimed to thin walls of the manufactured devices disclosed herein. In some instances, the methods comprise containing a molten liquid metal in a trowel device disclosed herein. In some instances, the methods comprise attaching the trowel device to the print head by a moveable armature. In some instances, the methods comprise containing a molten liquid metal in a roller device disclosed herein. In some instances, the methods comprise attaching the roller device to the print head by a moveable armature. In some instances, the methods comprise applying a compressive force to the molten liquid metal during melt solidification. In some instances, the methods comprise containing the molten liquid metal in the roller device during initial melting and applying a compressive force with the roller device to the molten liquid metal during melt solidification. In some instances the molten liquid metal is a molten liquid melt pool. The advantages of using said methods with a moveable armature include the ability to deposit thin walls without subtractive post-processes, deposit material at a faster or slower rate than possible without the moveable armature, and improve material quality and solidified surface roughness.

In some embodiments, an additive layer manufacturing process is used to manufacture and 3D print a shear-coaxial baffled element injector. In some cases, is a method of manufacturing an injector for combustion of a first and a second propellant using additive layer manufacturing, comprising: applying a first material to a region of a first, central injection channel connectable to a first propellant supply for a first propellant; heating the region of the first, central injection channel by a laser beam such that the first material is added to the first, central injection channel; and cooling the first, central injection channel comprising the first material; applying a second material to a region of a second injection channel being connectable to a second propellant supply for a second propellant; and heating the region of the second, injection channel by a laser beam such that the second material is added to the second, central injection channel; and cooling the second, injection channel comprising the second material.

In certain embodiments, the method also comprises applying an additional material to a region of the injector; heating the region of the injector by a laser beam such that the material is added to the injector; and cooling the injector comprising the additional material, to form an injector comprising at least one integrated baffled element.

In some embodiments, an additive layer manufacturing process is used to manufacture a shear-coaxial baffled element injector integrated within a small payload launch vehicle.

In some embodiments, is a method of manufacturing a shell-like structural component for a vehicle using additive layer manufacturing, comprising: applying a first material to a region of the shell-like structural component in a deposition pattern that enables selective compliance of the structure through anisotropic material properties. In some embodiments, the method described herein comprises a deposition pattern providing more compliance in the interlayer direction than the layerwise direction. In some embodiments, the deposition method may affect one or more of the following: layer orientation control, deposition direction control, melt pool width and/or thickness control, grain solidification control, heat input control, or alloy gradient control. The resulting properties and selective compliance of the shell-like structure allow for deterministic load pathways and optimized structural mass, properties, safety, and reliability among other benefits.

A method for manufacturing a shell-like structural component for a vehicle using additive layer manufacturing, comprising: applying a first material to a region of the shell-like structural component; heating the region of the shell-like structural component such that the first material is added to the shell-like structural component; and cooling the shell-like structural component comprising the first material, such that an internal stress is generated within the shell-like structural component resulting in the selective pre-tensioning or pre-compressing of the shell-like structural component. In some embodiments, the selective pre-tensioning or pre-compressing does not result in substantial bending. In some embodiments, the selective pre-tensioning or pre-compressing results in less than 1%, 2%, 3%, 4%, 5%, 6% or 7% bending of the structural component. In some embodiments, the heating comprises contact with at least one laser beam.

### Deposition Systems and Devices

Provided herein are deposition systems and deposition devices for additive manufacturing. As used herein, the term “device” may be used interchangeably with the term “apparatus,” unless specified otherwise. Deposition systems and devices disclosed herein may comprise a heat source to apply heat to a portion of a work piece to melt the portion of the work piece. Deposition systems disclosed herein may comprise an applicator to deposit material to the melted portion of the work piece to form a layer of material on the work piece. In some instances, the applicator is a printhead. Deposition systems disclosed herein may comprise a cooler to cool the formed layer of material on the work piece to a crystallization state of the material. Non-limiting examples of coolers are gas coolers and cryogenic coolers. In some embodiments, the cooler is used to remove heat from system that is produced by one or more lasers that are internal to the system and system hardware with visibility to the melt pool radiation. This advantageously minimizes thermal expansion's effect on the laser alignment.

In some embodiments, deposition systems comprise a stress-relieving apparatus configured to apply a stress-relieving process on the cooled layer of material on the work piece. In some embodiments, the stress-relieving apparatus is designed to modify the material by heating or cooling the material. In some embodiments, the stress-relieving apparatus is designed to mechanically modify the material. In some embodiments, the stress-relieving apparatus is able to impart a compressive stress within the material. In some embodiments, the stress-relieving apparatus is able to counteract a residual tensile stress of the material. In some embodiments, the stress-relieving apparatus is able to thermally relax the material such that tensile residual stresses regress to their yielding points. In some embodiments, the stress-relieving apparatus delivers vibrations which plastically deform material grains to reduce or eliminate residual stress. The advantages of such a means to reduce or eliminate residual tensile stress are such that deformation, crack formation, low material quality, low material strength, grain dislocations are sufficiently affected, removed, or improved from the work piece in-situ as material is deposited. In some instances, the stress-relieving apparatus comprises a peening module. Non-limiting examples of a peening module include a hammer, a laser, vibratory system, metal shot (e.g., that is blasted at the work piece). In some instances, the peening modules employ a solid shot that is frozen from material normally at a liquid or gaseous state at ambient conditions (e.g., that is blasted at the work piece).

Provided are deposition systems for efficient controlled additive layer deposition. In certain embodiments, deposition systems disclosed herein comprise one, two, three or more robotic arms with end effectors. In some cases, at least one first robotic arm performs metallic deposition, and at least one second robotic arm performs milling. In certain embodiments, the first and second arms work simultaneously to first deposit, and then remove portions of the deposited material.

### Print Head

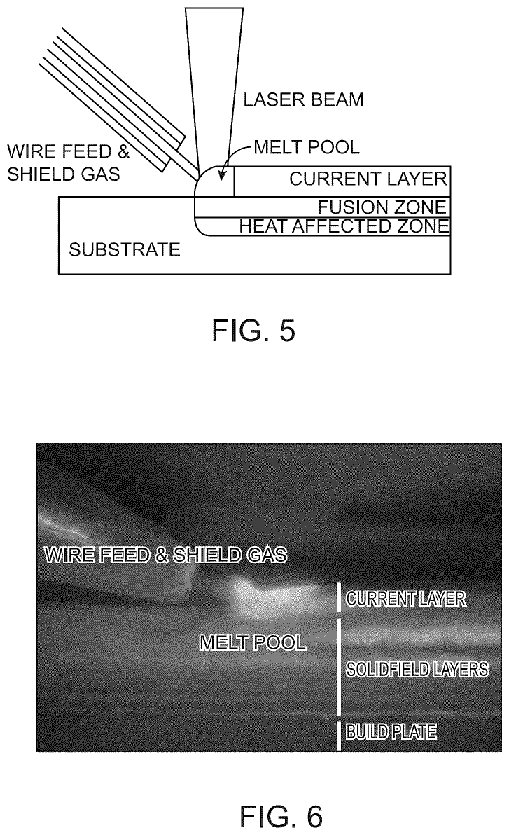

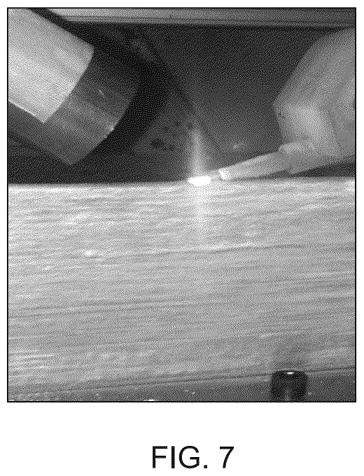

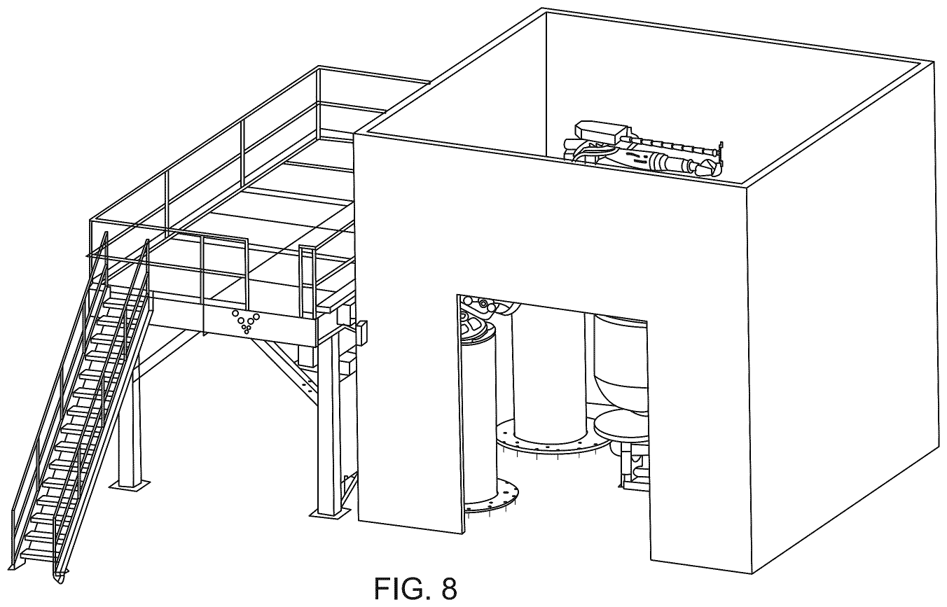

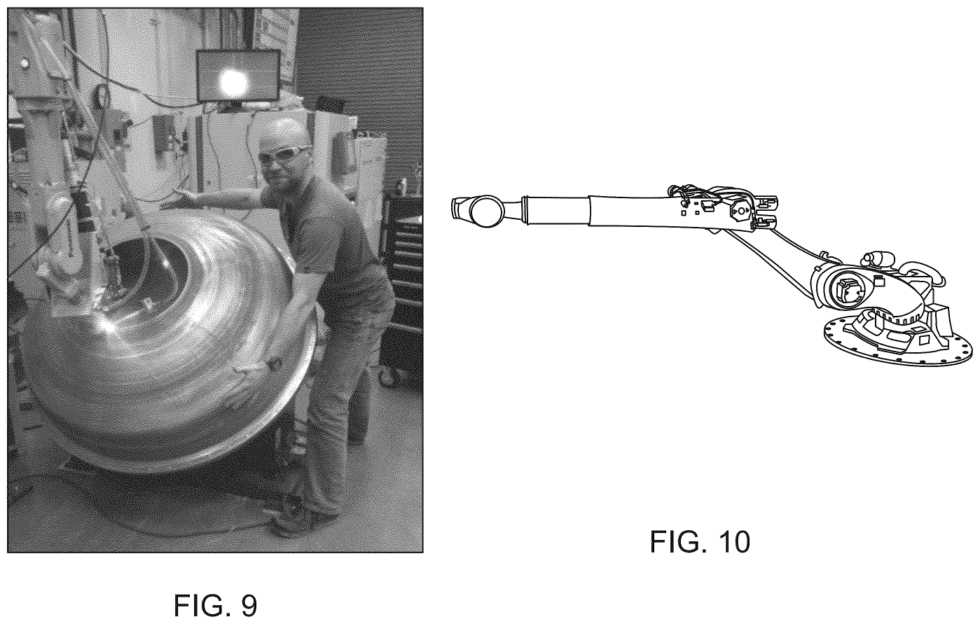

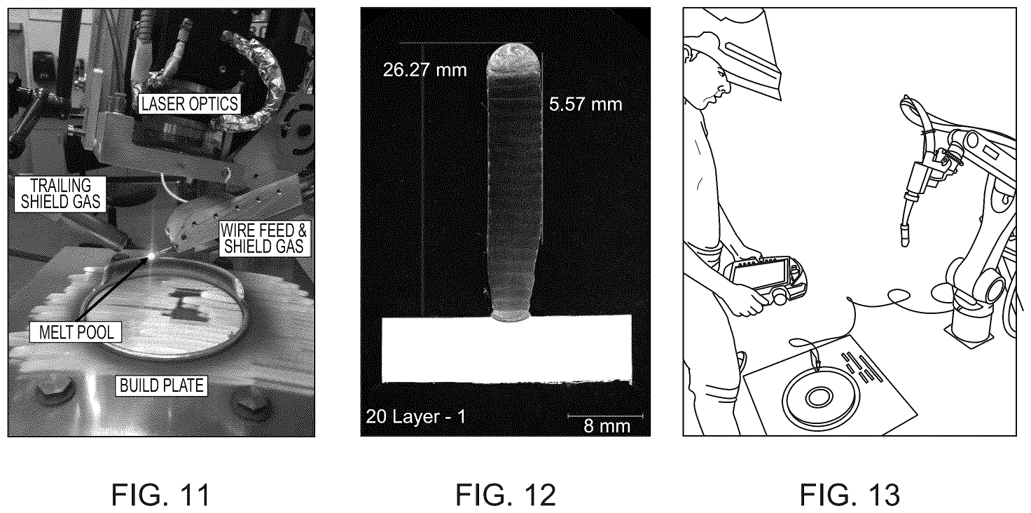

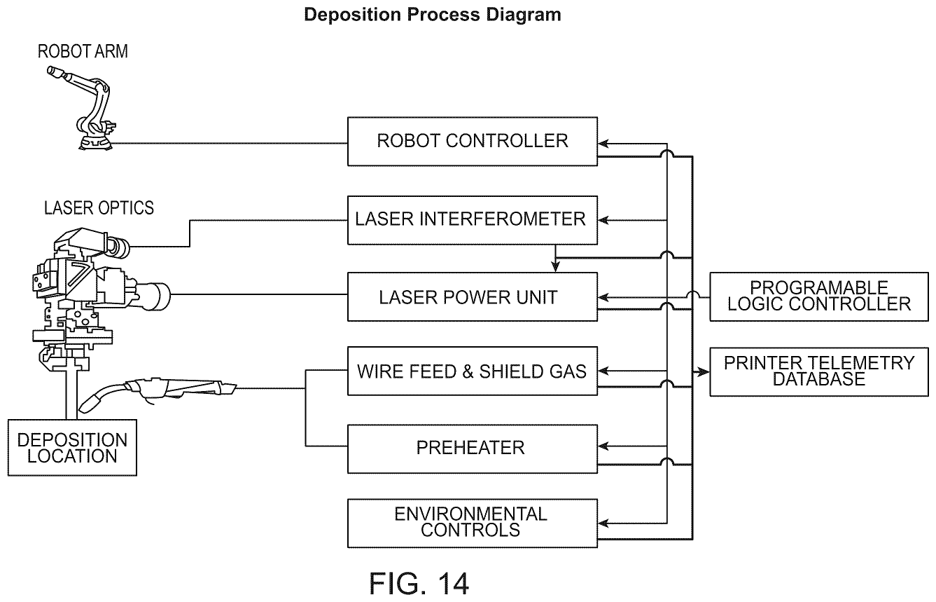

In some instances, the deposition system comprises a print head, as exemplified in FIGS. 5 and 6. In some embodiments, a print head comprises a high power optic device which sufficiently focuses an energy beam onto a wire. In some embodiments, said wire is fed from a wire feeder system. In some embodiments, said wire is fed from a wire feeder guide tip mounted on the print head via an armature. In some embodiments, said wire feeder guide tip employs a shielding gas nozzle sufficient to coat the wire and melt pool and energy beam focal point with an inert shield gas. In some embodiments, there is at least one optic. In some embodiments, there is at least one energy beam. In some embodiments, there is at least one optic and at least one energy beam. In some embodiments, there is one optic to three optics. In some embodiments, there is at least one optic and at least one energy beam. In some embodiments, there are one to three energy beams. In some embodiments, there are up to three optics and up to three energy beams. In some embodiments, there is at least one wire feeder. In some embodiments, there is at least one guide tip. In some embodiments there is one wire feeder. In some embodiments, there is one guide tip. In some embodiments, there are two wire feeders. In some embodiments, there are two guide tips. In some embodiments, there are one to four shielding gas nozzles. In some embodiments, there is one shielding gas nozzle. In some embodiments, there are two shielding gas nozzles. In some embodiments, there are three shielding gas nozzles. In some embodiments, there are four shielding gas nozzles. At least one of the shielding gas nozzles may be independently flowing from around a wire feeder guide tip and are present leading the melt pool, trailing the melt pool, or to the side or top of the melt pool, or all or any combination thereof.

In some embodiments, the print head is between about six inches and about three feet in height. In some embodiments, the print head is between about 2 inches wide and 20 inches wide. In some embodiments, the print head is between about 2 inches deep and 16 inches deep. In some embodiments, the print head is approximately 24″ tall, 12″ wide, and 8″ deep. In other embodiments, the print head may be miniaturized to be approximately 6″ tall, 2″ wide, and 2″ deep. In some embodiments, the print head does not include a (decorative) casing enclosure.

As used herein with regards to a numerical value, the term “about” refers to a number that is plus or minus 10% of that number. As used herein with regards to a numerical range, the term “about” refers to that range minus 10% of the range's lowest value and plus 10% of the range's greatest value.

In some embodiments, all exposed surfaces to the high energy beam radiation or reflection are actively cooled with a closed loop fluid circuit. In some embodiments, all exposed surfaces to the high energy beam radiation or reflection are actively cooled with an open loop cooling fluid circuit. In some embodiments, all exposed surfaces to the high energy beam radiation or reflection are passively cooled by means comprising of an applied reflective coating, a heat sink, natural convective cooling, and conductive cooling. In some embodiments, all exposed surfaces to the high energy beam radiation or reflection are passively cooled by means comprising of a highly polished surface, a heat sink, natural convective cooling, and conductive cooling. In some embodiments, said cooling means is selectively applied to regions or components of the print head to impart thermal expansion control of the print head assembly. In some embodiments, a high power optic device comprises a metallic housing, one or more transparent lenses, one or more reflective mirror lenses, one or more one-way mirror elements, a collimator element, an air or inert gas knife, and a high power energy beam fiber connection. In some embodiments, a high power optic device comprises a metallic housing, one or more magnetic lenses, and one or more magnetic steering devices.

In some embodiments, the wire feeder system comprises a wire drum feed unit. In some embodiments, the wire feeder system comprises a spool feed unit. In some embodiments, the wire feeder system comprises a roller system for pushing the wire. In some embodiments, the wire feeder system comprises a low friction coated flexible feed tube. In some embodiments, the wire feeder system comprises a roller system pulling the wire. In some embodiments, the wire feeder system comprises a device to balance wire feeder tension. In some embodiments, the wire feeder system comprises a device for providing wire feed rate tolerance between the pusher roller system and puller roller system which may prevent at least one of buckling, kinking, and inconsistent feeding of the wire. In some embodiments, the wire feeder system comprises a guide tip to guide the wire to at least one of the work piece, melt pool, and energy beam to a focal or near-focal point. In some embodiments, the wire feed guide tip comprises at least one of a nickel alloy, a copper alloy, a tungsten alloy, and a ceramic material. In some embodiments, the wire feed guide tip comprises a coated metallic material where the coating is a reflective material. In some embodiments, the wire feed guide tip comprises an active cooling system. The active cooling system may comprise a cooling jacket or internal cooling channels in which a coolant fluid may flow. In some embodiments, the wire feed guide tip comprises a passive cooling system. The passive cooling system may comprise at least one of an applied reflective coating, a heat sink, a natural convective cooling, and conductive cooling.

Some deposition systems disclosed herein comprise a wire straightening device. Some wire straightening devices comprise a roller arrangement. A roller arrangement may allow for feeding wire through at a high rate and straightening the wire as it feeds. In some embodiments, this straightening imparts a yielding stress onto the wire sufficient to straighten it. A roller arrangement is able to consistently straighten the wire. Roller arrangements may be adjustable and interchangeable for varying wire materials, wire diameters, feed speeds, wire cast amounts, and wire spool diameters. Some wire straightening devices comprise a static blade arrangement. A static blade arrangement may require fewer moving parts than a roller arrangement, reducing required maintenance of the wire straightening device. A static blade arrangement can also provide friction against the wire to potentially remove any particulate contaminants while completing the wire straightening step. Some wire straightening devices comprise a heating device. The heating device may be capable of at least one of the following: electric resistive heating, inductive heating, radiative heating, conduction heating, and convective heating. Some wire straightening devices comprise a tensioning element. The tensioning element may be capable of enacting a force sufficient to cause material yielding. In some embodiments, a tensioning element holds the wire at two points and operates by using either spring force, hydraulic force, pneumatic force, or screw tensioning force to tension the wire directly. In some embodiments, a tensioning element comprises a device which the wire feeds through and around, and operates by using either spring force, hydraulic force, pneumatic force, or screw tensioning force to tension the wire indirectly.

Some deposition systems disclosed herein comprise a trowel device. In some instances, the trowel device is a device that sufficiently contains a molten liquid metal disclosed herein. In some instances, the trowel device is a device that sufficiently contains a molten liquid metal during initial melting through solidification. In some instances, the trowel device is attached by a moveable armature to the print head. In some instances, the trowel device is geometrically formed to control melt pool geometry through solidification. In some instances, the trowel device is actively shaped to control melt pool geometry through solidification. In some instances, the trowel device is manufactured from a material that is not sufficiently wetted by the molten melt pool material as to cause a bonding force between the trowel and the solidified material. In some instances, the trowel device is manufactured from a ceramic material. In some instances, the trowel device is manufactured by a refractory metallic material. In some instances, the trowel device provides a force on the melt pool via magnetic repelling or attractive means. In some instances, the trowel device provides a force on the melt pool via magnetic induction means. In some instances, the trowel device is shaped to sufficiently contain a melt pool. In some instances, the trowel device is shaped to sufficiently contain a melt pool by enclosure within either a 2-sided or 3-sided trowel cross sectional geometry. In some instances, the trowel device is shaped to sufficiently contain a melt pool with a cross sectional geometry sufficiently constraining approximately 10-90% of the melt pool cross sectional circumference of any number of sides and shape. In some instances, the trowel device contains the molten liquid through solidification to ensure that the melt pool cools into a desired geometry that is within the bounds of the trowel. Advantages of the trowel device include the ability to deposit metal material in a layer by layer process and achieve an as-deposited wall thickness that is thinner or thicker or a different shape than that possible using only process parameter control, which relies on gravity, surface tension, and wetting properties of the melt pool. Additional advantages include the ability to deposit material in sufficiently higher angles relative to the vector of gravity without material droop. Additionally, the trowel device may achieve a desirable uniform work piece surface finish without the need for post processing.

Some deposition systems disclosed herein comprise a roller device. In some instances, the roller device is also a trowel device, as disclosed herein. In some instances, the roller device is a device that sufficiently contains the molten liquid melt pool during initial melting. In some instances, the roller device is capable of applying a compressive force to a solidifying metal during solidification of the molten metal. In some instances, the compressive force is provided by a spring. In some instances, the compressive force is provided by a motor. In some instances, the roller device is attached by a moveable armature to the print head. In some instances, the compressive force is provided by a moveable armature to the print head. In some instances, the compressive force is provided by a spring force, hydraulic force, pneumatic force, or tensioning force. In some instances, the roller device comprises a single roller. In some instances, the roller device comprises at least one roller.

### Deposition Arms

The deposition arms can include one or more of the following components to deposit a desired material, for instance aluminum wire in a desired shape, for instance neat-net-shape,

In some embodiments, deposition systems disclosed herein comprise a preheater. In some instances, the pre-heater is a power source. In some embodiments, a welding power source is used to induce electricity through the wire before it is fully melted. By way of non-limiting example, the welding power source may induce 700 amps of electricity in the wire. In some instances, the welding power source may induce about 300 amps to about 1000 amps of electricity in the wire. This raises the wire temperature sufficiently to allow effective laser coupling. Additionally, the preheating reduces the conduction from the melt pool into the wire, reducing the laser power needs at the melt pool.

In some embodiments, deposition systems disclosed herein comprise a laser. The laser may be referred to as a primary laser. In some cases, a fiber laser is used to melt the wire as it reaches the deposition location. This laser is routed through focusing optics at the end of the robotic arms.

In some embodiments, deposition systems disclosed herein comprise a feedback laser. In some embodiments, a feedback laser is coupled with the primary laser to monitor the melt pool. This accounts for quality feedback on melt pool intensity and size, along with location feedback for both lateral placement and height. The quality is recorded to ensure proper melt pool performance. The location data is used for closed loop feedback on the robotic arm placement and deposition layer thickness.

In some embodiments, deposition systems disclosed herein comprise a wire feed. The wire feed may be used to obtain a required material deposition rate. The wire feed may be used to obtain the required material deposition rates necessary to produce a one-week upper stage print.

### Milling Arms

The milling arms are used to obtain the desired wall thickness and surface finish required for the upper stage structure. In some instances wherein robotic arm accuracy may not exhibit the tolerances needed by the upper stage, through additional feedback systems are incorporated to obtain the accuracy desired.

In some embodiments, one or more printing apparatuses and/or processes described herein can be configured to print an entire launch vehicle. In some embodiments, one or more printing apparatuses and/or processes described herein can be configured to print a first stage of a launch vehicle. In some embodiments, one or more printing apparatuses and/or processes described herein can be configured to print a second stage of a launch vehicle. For example, at least an aft dome of a second stage of a launch vehicle maybe printed using one or more processes and/or apparatuses described herein, including an aft dome having a dimension of about 4.5 feet in diameter and about 2 feet in height. In some embodiments, nozzle extension structures of the launch vehicle may be printed. In some embodiments, one or more steps of the manufacturing process for fabricating a launch vehicle can be automated as described herein. In some embodiments, automating the manufacturing process may provide significant cost savings, while also providing a reliable launch vehicle, allow for short launch vehicle build times, and facilitate design and customization of the launch vehicle. In some embodiments, one or more processes described herein can enable printing of a Falcon 9-sized aluminum structure in less than about 30 days. In some embodiments, one or more processes described herein can enable printing of a SLS-sized tank in less than about 45 days.

In some embodiments is a method described herein comprising at least one of in-situ laser scraping, mechanical scraping, peening or passivation cleaning of at least one of: the portion of the work piece for deposition, the weld wire to remove oxides, hydrocarbons, soot, water, and particulate.

In some embodiments is a method described herein, comprising near real-time modification of the deposition path and build parameter commands based on previously-built section of print.

In some embodiments, the method comprises modifications including for instance allocation for component warping, process parameter variations, gradient material properties, and as-built component reconstruction based on melt pool sensor feedback.

Provided herein are methods of additive manufacture further comprising in process control by quantitative optical tomography. In some embodiments are artificial intelligence control system, neural network control system, deep learning control system, and control systems using relationship between multiple sensor's data to intuit new data insight and affect the control of the additive manufacturing system.

### Propellant Supply System and Apparatuses

Disclosed herein are systems and apparatuses configured to supply a propellant from a propellant storage to a launch vehicle rocket engine of a launch vehicle. In some embodiments, the system or apparatus comprises a motor and an impeller. Generally, an impeller impels propellant through the apparatus or system. A non-limiting example of an impeller is a pump. In some embodiments, the impeller is configured to drive the first propellant from the propellant storage through a supply line towards the rocket engine.

In some embodiments, the system or apparatus comprises a heat exchanger configured to heat the propellant, thereby providing a heated propellant. In some embodiments, the heat exchanger heats the propellant to cause a phase change of the propellant. In some embodiments, the heat exchanger does not cause combustion of the propellant. In some embodiments, the system or apparatus comprises a gas generator. In some embodiments, the system or apparatus comprises a pre-burner. In some embodiments, the propellant exits the gas generator or pre-burner as a working fluid. The working fluid may exit either a gas generator or pre-burner as it undergoes a transformation from propellant to working fluid. Working fluid may exit either a gas generator or pre-burner as it undergoes combustion. Combustion may be caused by burning the propellant with a small amount of either fuel or oxidizer depending on if the preburner/gas generator is oxygen-rich or fuel-rich.

In some embodiments, the system or apparatus comprises an electrical generator. The electrical generator may comprise an electricity generator. The electrical generator may comprise a gas turbine. In some embodiments, the electrical generator comprises an electricity generator and a gas turbine, which may be simply referred to as a turbine herein. In some embodiments, the turbine is configured to receive the heated propellant. In some embodiments, the gas turbine comprises a turbine shaft. In some embodiments, the gas turbine comprises a first turbine shaft and a second turbine shaft. In some embodiments the first and the second turbine shafts are configured to rotate independently of one another in response to flow of the heated propellant through the gas turbine. In some embodiments, the first turbine shaft is mechanically coupled to a motor shaft of the pump for transferring rotation of the first turbine shaft to the motor shaft of the pump for transferring mechanical energy from the gas turbine to the motor shaft for driving the pump, and the second turbine shaft is mechanically coupled to a generator shaft of the electricity generator for generating electrical power, the electricity generator being configured to generate electrical power at a rate independent of a rate at which the mechanical energy is transferred from the gas turbine to the motor shaft. Systems and apparatuses disclosed herein may comprise an electrical energy storage configured to store electricity generated by the electricity generator to power at least one of the pump and a second pump configured for continuously driving a second propellant towards the rocket engine.

In some embodiments, systems and apparatuses disclosed herein comprise a heat exchanger, wherein the heat exchanger comprises a regenerative cooling channel on at least a portion of the rocket engine. In some embodiments, the regenerative cooling channel is on at least one of a portion of an outer surface of a combustion chamber to cool the combustion chamber. In some embodiments, the regenerative cooling channel is on at least one of a portion of an outer surface of a nozzle of the rocket engine. In some embodiments, the regenerative cooling channel is on at least one of a portion of an outer surface of a gas generator. In some embodiments, the regenerative cooling channel is on at least one of a portion of an outer surface of a pre-burner. In some embodiments, the regenerative cooling channel is on at least one of a portion of an outer surface of a battery. In some embodiments, it is advantageous to include cooling channels in the recited locations because the engine is typically the largest source of heat on the vehicle and needs to be actively cooled to achieve high performance. In some embodiments, the systems and apparatuses comprise a supply line from the propellant storage to the electricity storage to cryogenically cool the electricity storage. In some embodiments, the systems and apparatuses comprise a supply line from the propellant storage to the motor of the pump for supplying the first propellant to the motor to cryogenically cool the motor of the pump.

In some embodiments, the systems and apparatuses disclosed herein are configured to receive at least one propellant. In some embodiments, the systems and apparatuses disclosed herein are configured to store at least one propellant. In some embodiments, the systems and apparatuses disclosed herein comprise at least one propellant. In some embodiments, the systems and apparatuses disclosed herein are configured to receive or store a first propellant and a second propellant. In some embodiments, the systems and apparatuses disclosed herein comprise a first propellant and a second propellant. The first propellant and the second propellant may be the same. The first propellant and the second propellant may be different. Propellants are generally materials, fluids or gases that can drive, rotate or power a shaft or system/apparatus component such as a turbine. The propellant may comprise a fuel. The propellant may comprise a liquid. The liquid may be a natural gas. The liquid may be liquefied natural gas. The propellant may be a liquid that can undergo a phase change from a liquid to a gas or supercritical fluid. The propellant may comprise an oxidant. The propellant may comprise an alkane. The alkane may comprise of kerosene or similar long chain hydrocarbon derived fuels (ex. RP-1, RP-2, JP-3, JP-10, or other specifications for refined kerosene products), liquid methane, liquid ethane, liquid propane, liquid butane, liquid natural gas, or a combination thereof. The propellant may comprise of an unsaturated hydrocarbon. The unsaturated hydrocarbon may comprise of ethylene, propylene, 1,2-butadiene, 1,3-butadiene, methylacetylene, or a combination thereof. The propellant may comprise an oxidizer. The oxidizer may comprise of liquid oxygen, nitrogen tetroxide, hydrogen peroxide, nitrous oxide, liquid fluorine, or a combination thereof. The propellant may comprise of liquid hydrogen, hydrazine, unsymmetrical dimethylhydrazine (UDMH; 1,1-dimethylhydrazine), nonomethylhydrazine (MMH), ethanol, methanol, or a combination thereof. In some instances, the propellant comprises a cryogenic liquid. In some instances, the propellant comprises a subcooled liquid. In some instances, the propellant comprises a room temperature liquid. In some instances, the propellant comprises liquid oxygen. In some instances, the propellant is liquid oxygen.

In some embodiments, the system and apparatuses comprise a first impeller and a second impeller. In some embodiments the first impeller is configured to receive or impel a liquid fuel and the second impeller is configure to receive or impel a liquid oxidant into the rocket engine. In some embodiments, the first impeller and the second impeller are configured to provide a liquid fuel and a liquid oxidant respectively into the rocket engine. Respective amounts of liquid fuel and liquid oxidant can be described as a volumetric ratio of liquid fuel to liquid oxidant. In some instances the volumetric ratio of liquid fuel to liquid oxidant falls within a range of a volumetric ratio of about 5:1 to a volumetric ratio of about 0.2:1. In some embodiments, the first impeller and the second impeller are configured to provide a liquid fuel and a liquid oxidant respectively into the rocket engine within a range of volumetric ratio from about 3 to about 0.3. In some embodiments, the first impeller and the second impeller are configured to provide a liquid fuel and a liquid oxidant respectively into the rocket engine within a range of volumetric ratio from about 2 to about 0.5. In some embodiments, the first impeller and the second impeller are configured to provide a liquid fuel and a liquid oxidant respectively into the rocket engine at a volumetric ratio of about 1.5 to about 0.6. In some embodiments, the first impeller and the second impeller are configured to provide a liquid fuel and a liquid oxidant respectively into the rocket engine at a volumetric ratio of about 1.2 to about 0.7. In some embodiments, the first impeller and the second impeller are configured to provide a liquid fuel and a liquid oxidant respectively into the rocket engine at a volumetric ratio of about 1.1 to about 0.8. In some embodiments, the first impeller and the second impeller are configured to provide a liquid fuel and a liquid oxidant respectively into the rocket engine at a volumetric ratio of about 1.0 to about 0.85. In some instances the volumetric ratio of liquid fuel to liquid oxidant is about 0.9.

In some embodiments, the impeller comprises a motor. In some embodiments, the motor of the impeller comprises an electrical motor. In some embodiments, the motor comprises a variable reluctance motor. In some embodiments, a variable reluctance motor advantageously enables high system power density at very high speeds of between 15,000 and 250,000 RPM, minimizing mass and increasing payload to orbit. In some embodiments, the motor comprises a brushless DC motor. In some embodiments, a brushless DC motor is able to operate at high speeds and power densities due to the non-contacting commutation of the motor. For example, a vehicle operated in the environment of space, a non-contacting electrical commuter such as a brushless DC motor is important to prevent arcing and allow control of the motor, while also reducing friction and enabling high speed operation. In some embodiments, the motor comprises an AC induction motor. An AC induction motor may be similar to a brushless DC motor, but uses a separate power inverter circuit to provide the necessary power phase and waveform to the motor instead of a brushless DC motor internal electrical commutation circuit. The separate power inverter circuit may enable better motor and controller packaging on the described rocket engine pumping system, as compared to other motor types described herein.

In some embodiments, the systems and apparatuses disclosed herein comprise an impeller, wherein the impeller is configured to pump a quantity of the first propellant through the heat exchanger and the electrical generator so as to generate at least 10 kilowatts of power during a thrusting time period. In some embodiments, the systems and apparatuses disclosed herein comprise an impeller, wherein the impeller is configured to pump a quantity of the first propellant through the heat exchanger and the electrical generator so as to generate at least about 50 kilowatts of power during a thrusting time period. In some embodiments, the systems and apparatuses disclosed herein comprise an impeller, wherein the impeller is configured to pump a quantity of the first propellant through the heat exchanger and the electrical generator so as to generate at least about 1,000 kilowatts of power during a thrusting time period. In some embodiments, the systems and apparatuses disclosed herein comprise an impeller, wherein the impeller is configured to pump a quantity of the first propellant through the heat exchanger and the electrical generator so as to generate between about 50 kW and about 10,000 kW of power. In some embodiments, the systems and apparatuses disclosed herein comprise an impeller, wherein the impeller is configured to pump a quantity of the first propellant through the heat exchanger and the electrical generator so as to generate at most about 20,000 kilowatts of power during a thrusting time period.

In some embodiments, the impeller is configured to pump a quantity of a propellant through the heat exchanger and the electrical generator to provide a high power output continuously for a period of at least about 20 seconds, at least about 30 seconds, at least about 60 seconds, or at least about 80 seconds. In some embodiments, the impeller is configured to pump a quantity of the propellant through the heat exchanger and the electrical generator to provide a high power output continuously for a period of about 30 to about 600 seconds. In some embodiments, the impeller is configured to pump a quantity of the propellant through the heat exchanger and the electrical generator to provide a high power output continuously for a period of about 30 to about 400 seconds. In some embodiments, the impeller is configured to pump a quantity of the propellant through the heat exchanger and the electrical generator to provide a high power output continuously for a period of about 60 to about 400 seconds.

In some embodiments, the systems and apparatuses disclosed herein are configured to supply at least one of mechanical energy from rotation of the first turbine shaft and electrical energy from the electrical energy storage sufficient to drive the pump to provide a quantity of the first propellant into the rocket engine during the launching period for providing a thrust. In some embodiments, the thrust is about 3,000 lbf to about 120,000 lbf. In some embodiments, the thrust is about 3,000 lbf to about 100,000 lbf. In some embodiments, the thrust is about 5,000 lbf to about 80,000 lbf. In some embodiments, the thrust is about 5,000 lbf to about 65,000 lbf. In some embodiments, the thrust is about 5,000 lbf to about 50,000 lbf. In some embodiments, the thrust is about 5,000 lbf to about 20,000 lbf. In some embodiments, the thrust is about 8,000 lbf to about 12,000 lbf. In some embodiments, the thrust is about 9,000 lbf to about 11,000 lbf. In some embodiments, the thrust is at least about 3,000 lbf. In some embodiments, the thrust is at least about 5,000 lbf. In some embodiments, the thrust is at least about 8,000 lbf.

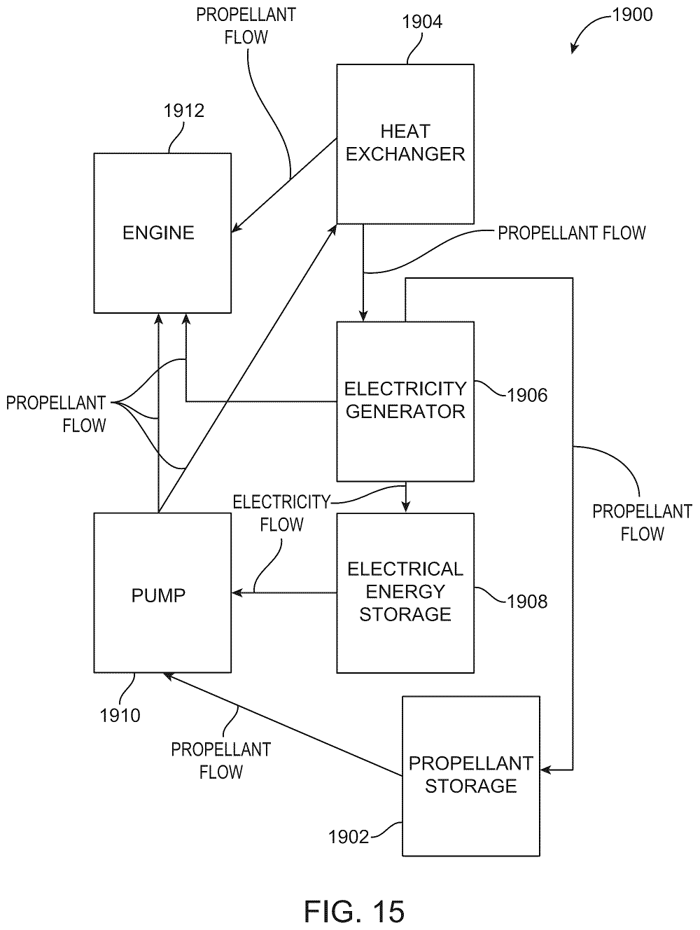

Disclosed herein are liquid propellant systems for powering a rocket engine of a launch vehicle. Liquid propellant systems disclosed herein generally comprise at least one propellant storage. FIG. 15 is a simplified schematic diagram including a liquid propellant supply system 1900 for supplying a propellant to a rocket engine 1912 of a launch vehicle. In some embodiments, the liquid propellant systems disclosed herein comprise a plurality of propellant storages to power the rocket engine with multiple propellants. The rocket engine 1912 may be configured to generate sufficient thrust for launching a launch vehicle comprising one or more stages away from earth. The liquid propellant supply system 1900 can include a propellant storage 1902, a heat exchanger 1904, an electrical generator 1906, an electrical energy storage 1908 and a pump 1910. As will be described in further details herein, the first propellant can be supplied from the propellant storage 1902 to the pump 1910, and the pump 1910 can pump the first propellant to the rocket engine 1912 and/or the heat exchanger 1904. In some embodiments, the first propellant may be split and supplied both to the rocket engine 1912 and the heat exchanger 1904. The portion of the first propellant flowed through the heat exchanger 1904 can then be flowed into the (1) rocket engine and/or (2) the electrical generator 1906. The electrical generator 1906 may comprise an electricity generator and a gas turbine. The first propellant exiting the electrical generator 1906 can be (1) fed into the rocket engine 1912, (2) used for autogenous pressurization, and/or (3) dumped overboard.

The gas turbine of the electrical generator 1906 may comprise independently rotatable turbine shafts for coupling to a motor shaft of the pump 1910 and a generator shaft of the electricity generator such that rotation of the turbine shafts due to flow of the first propellant through the turbine can independently rotate the motor shaft to drive the pump 1910 and the generator shaft to generate electricity.

Electricity generated by the electrical generator 1906 can be stored in the electrical energy storage 1908. The electricity generated by the electrical generator 1906 and stored in the electrical energy storage 1908 may be used to power a second pump different from the pump 1910 to propel a second propellant to the rocket engine 1912. In some embodiments, the first propellant may comprise a fuel and the second propellant may comprise an oxidant. For example, the first propellant may be liquid natural gas (LNG) and the second propellant may be liquid oxygen (LNG).

The liquid propellant system 1900 may enable generation of both mechanical energy for powering a fuel pump for pumping fuel to the rocket engine, and electrical energy to power a oxidant pump for pumping oxidant to the rocket engine by using a heat exchanger which can heat the fuel to a supercritical phase. Generation of the mechanical energy and the electrical energy may be independent of one another such that control of the pumping of the fuel to the rocket engine and control of the oxidant to the rocket engine may be achieved independent of one another. Independent control of the pumping of the fuel and oxidant improves precision of control, thereby increasing vehicle safety. The heat exchanger may be regenerative cooling channels formed on or over one or more surfaces of the rocket engine, thereby providing a compact design for an energy generation source. Generation of mechanical energy and electrical energy using a heat exchanger, and/or storage of electricity generated onboard the launch vehicle, may enable increased energy available onboard, thereby facilitating a scalable energy generation design for rocket engines of launch vehicles having various sizes.

The rocket engine 1912 may include a main combustion chamber configured to oxidize a fuel. An oxidant and a fuel can be supplied into the main combustion chamber such that oxidation of the fuel can generate a combustion product which can be expelled at high speed through a nozzle or other structure of the engine to generate thrust. In some embodiments, the liquid propellant can comprise a liquid fuel. The liquid fuel may be liquid natural gas (LNG). For example, the liquid propellant may be liquid natural gas. The oxidant may be liquid oxygen (LOX). In some embodiments, the liquid propellant supply system 1900 may be configured to supply the liquid fuel to the rocket engine 1912, while the oxidant can be supplied to the rocket engine 1912 using a separate different system. For example, the oxidant may be supplied to the rocket engine 1912 using a second pump separate from the pump 1910 (not shown).

The liquid propellant supply system 1900 as described herein can enable supply of liquid propellant at continuous, high mass flow rate that is desired for high energy, limited duration applications such as launch vehicle applications. The liquid propellant supply system can enable continuously driving an electrical drive system for continuously driving a propellant pump (e.g., pump 1910) during a thrusting time period, including for a thrusting time period sufficient to launch the launch vehicle away from Earth. In some embodiments, the liquid propellant supply system 1900 may be configured to provide sufficient electrical power to provide at least about 10 kilowatts of power continuously during a thrusting time period. The thrusting time period may be at least about 60 seconds. In some embodiments, thrusting period may be at least about 90 seconds, such as for a staged booster of a launch vehicle. In some embodiments, the liquid propellant supply system 1900 may be configured to supply propellant to the rocket engine for lower power requirement applications, such as upper stages applications. Upper stage applications may require less power over shorter periods of time. In some embodiments, liquid propellant supply system 1900 may be configured to provide electrical power for such lower power requirement applications such that an energy density of at least about 50 watt hours per kilogram is provided.

Propellant storages disclosed herein may comprise one or more storage tanks configured to store a liquid propellant. The propellant storage may comprise a plurality of tanks for storing a liquid fuel, such as liquid natural gas.

The propellant storage 1902 can be in fluid communication with the pump 1910. For example, the liquid propellant system 1900 may comprise supply lines to supply the first propellant from the propellant storage 1902 to pump 1910 such that the first propellant can be supplied to the pump 1910. The first propellant can be pumped to one or both of the rocket engine 1912 and the heat exchanger 1904. In some embodiments, the first propellant flow at the pump 1910 can be split such that a portion of the first propellant exiting the pump is supplied to the rocket engine 1912 directly, for example without routing the first propellant through the heat exchanger 1904. The remaining portion of the first propellant can be supplied through the heat exchanger 1904 to be heated. In other embodiments, all of the first propellant exiting the pump 1910 can be supplied to the heat exchanger 1904. The liquid propellant system 1900 may comprise supply lines to supply the first propellant from the pump 1910 to the rocket engine 1912 and/or the heat exchanger 1904.

In some embodiments, the heat exchanger 1904 can be configured to heat the first propellant to a supercritical phase. The heat exchanger 1904 may be separate from the rocket engine 1912. However, in some embodiments, it will be understood that the heat exchanger 1904 may be on a portion or form a part of the rocket engine 1912. For example, the heat exchanger 1904 may comprise one or more channels along a surface of the rocket engine 1912. Heat generated within the rocket engine 1912 can be used to heat the first propellant as the first propellant flows through the channels. In some embodiments, the heat exchanger 1904 may comprise a plurality of regenerative cooling channels formed on at least a portion of an outer surface of the rocket engine 1912. The regenerative cooling channels may be on at least a portion of an outer surface of one or more of an injector, main combustion chamber and nozzle of the rocket engine 1904. In some embodiments, the regenerative cooling channels can run along at least a portion of outer surfaces of each of the injector, main combustion chamber and nozzle. In some embodiments, the regenerative cooling channels can run along at least a portion of outer surfaces of the main combustion chamber and the nozzle. Supplying the first propellant from the pump 1910 through the regenerative channels, for example along at least portion of a surface of the main combustion chamber and nozzle of the rocket engine 1912, may result in transformation of a first liquid propellant to a first propellant in a supercritical phase.

The first heated propellant, such as the supercritical propellant, can then be supplied to one or more of the rocket engine 1912 and the electrical generator 1906. In some embodiments, a portion of the first heated propellant exiting the heat exchanger 1904 can be supplied directly to the rocket engine 1912, for example without routing the first heated propellant through the electrical generator 1906. The remaining portion of the first heated propellant can be supplied to the electrical generator 1906 where the first heated propellant can be used to generate mechanical and/or electrical power. In some embodiments, all of the first heated propellant exiting the heat exchanger 1904 is supplied to the electrical generator 1906 for generating mechanical and/or electrical power.

In some embodiments, the electrical generator 1906 may comprise a gas turbine. The gas turbine can be configured to receive the first heated propellant from the heat exchanger 1904. One or more supply lines providing fluid communication between an outlet of the heat exchanger 1904 and an inlet of the electrical generator 1906 can be used to supply the first propellant in the supercritical phase to the gas turbine. In some embodiments, mechanical energy generated by the gas turbine can be transferred to the pump 1910 for driving an impeller of the pump 1910. For example, the supercritical propellant may rotate blades of the turbine as the supercritical propellant passes through the turbine. The rotating blades can in turn spin a shaft of the turbine. In some embodiments, the turbine shaft can be coupled to a motor shaft of the pump 1910 such that rotation of the turbine shaft rotates the motor shaft of the pump 1910, thereby driving the impeller of the pump 1910.

In some embodiments, the electrical generator 1906 may comprise an electricity generator coupled to the gas turbine. For example, the supercritical propellant may rotate blades of the turbine as the supercritical propellant passes through the turbine. The rotating blades can in turn spin a shaft of the turbine coupled to a generator shaft of the electricity generator such that electricity can be generated.

In some embodiments, the gas turbine may be coupled to both a motor shaft of the pump 1910 and a generator shaft of an electricity generator. In some embodiments, the gas turbine may be separately coupled to the motor shaft and the generator shaft of the electricity generator. For example, the turbine may comprise corresponding turbine shafts for coupling to the motor shaft and the generator shaft such that rotation of the motor shaft and the generator shaft of the electricity generator are independent of one another.

In some embodiments, the first propellant which exits the electrical generator 1906 is used for one or more of the following: dumped overboard, tank pressurization or reaction control thrusters, injected into any point in the main rocket engine (e.g., chamber and/or nozzle). In some embodiments, at least a portion of the first propellant exiting the electrical generator 1906 can be supplied to one or more tanks of the propellant storage 1902 to facilitate pressurization of the one or more tanks. The first propellant exiting the generator 1906 can facilitate maintaining sufficient pressure within liquid propellant storage tanks, for example such that the first propellant can be supplied from the tanks to pump 1910 at a desired rate. In some embodiments, at least a portion of the first propellant exiting the electrical generator 1906 can be dumped without further use by the liquid propellant system 1900. In some embodiments, at least a portion of the first propellant exiting the electrical generator 1906 may be injected into the rocket engine 1912 at a desired rate to provide desired thrust. In some embodiments, all of the first propellant exiting the generator 1906 is supplied to the rocket engine 1912. In some embodiments, at least a portion of the first propellant exiting the generator 1906 is supplied to the rocket engine 1912 and a portion is dumped overboard. In some embodiments, at portion of the first propellant exiting the generator 1906 is injected into the rocket engine 1912, a portion is dumped overboard, and a portion is used to pressurize one or more tanks of the propellant storage 1902.

Electrical power generated by the electrical generator 1906 can be supplied to the electrical energy storage 1908 and stored. In some embodiments, electrical energy stored by the electrical energy storage 1908 can be used to power one or more other pumps separate from the pump 1910. In some embodiments, electrical energy stored by the electrical energy storage 1908 can be used to power a pump for pumping an oxidant to the rocket engine 1912. In some embodiments, oxidant is not routed through a heat exchanger. In some embodiments, the oxidant is pumped from an oxidant storage into the rocket engine 1912, such as directly from one or more oxidant storage tanks into one or more portions of the rocket engine 1912. For example, the electrical energy storage 1908 may be discharged during a launching period to power an oxidant pump for pumping oxidant into the rocket engine 1912. In some embodiments, electrical energy stored by the electrical energy storage 1908 can be used to power to the pump 1910 for pumping the first propellant into the rocket engine 1912.

Heating of a propellant, such as a fuel, by a heat exchanger may advantageously provide both energy for driving a pump for pumping the fuel to the rocket engine and a separate pump for pumping an oxidant to the rocket engine. The heat exchanger may utilize heat generated from combustion within the rocket engine to heat the fuel such that the heated fuel can be supplied to a gas turbine to generate both (1) mechanical energy for driving the pump for pumping the fuel into the rocket engine and (2) electrical energy for driving a separate pump for pumping oxidant into the rocket engine. Independent coupling of the motor shaft of the pump for pumping the fuel to the rocket engine to the gas turbine, and of the generator of the electrical generator configured to generate the electrical energy to the gas turbine, advantageously enables decoupling of control of the separate pumps for pumping fuel and oxidant to the rocket engine. Generation of the mechanical and electrical energy using the heat exchanger and the fuel onboard the launch vehicle advantageously enables delivery of desired power to separate pumps for pumping fuel and oxidant to the rocket engine, for example to allow generation of sufficient thrust to launch vehicles of various sizes.

Power provided by the electrical energy storage 1908 can be configured to provide electrical power for high power, limited duration applications such as launch vehicle applications, including providing high power for at least about 60 to about 90 seconds. In some embodiments, the electrical energy storage 1908 can be configured to provide at least about 10 kilowatts of power during a thrusting time period. In some embodiments, the power source preferably has an energy density of at least about 50 watt hours per kilogram so as to provide adequate power and reduced mass.

In some embodiments, the electrical energy storage 1908 may comprise one or more of batteries, capacitors, and supercapacitors. In some embodiments, the electrical energy storage 1908 can include high power density batteries, capacitors, supercapacitors and/or counter rotating flywheels. In some embodiments, the electrical energy storage 1908 may comprise lithium-type batteries and/or supercapacitors. Electrical energy stored in the one or more batteries, capacitors, supercapacitors and/or counter rotating flywheels, may be used to power the pump 1910 to pump propellant from the propellant storage 1902 such that the propellant can be supplied at a desired rate to the rocket engine 1912 for combustion to generate the desired thrust. As described herein, the first propellant may be a fuel and an oxidant may be pumped by a second pump separate from the pump 1910. Electrical energy stored in the one or more batteries, capacitors, supercapacitors and/or counter rotating flywheels may be used to power the second pump. In some embodiments, the stored electrical energy may be used to power only the second pump. In some embodiments, the stored electrical energy may be used to power both the second pump and the pump 1910.

In some embodiments, the electrical energy storage 1908 comprises a plurality of batteries. For example, electricity generated by the electrical generator 1906 charges each of the plurality of batteries. The batteries may be interconnected in electrical series for desired voltage and power. In some embodiments, each of the batteries can have an energy density of at least about 50 watt hours per kilogram. In some embodiments, the batteries can release about one third of their energy in an 80 second time interval, for example to provide sufficient power for a launching application.

In some embodiments, the pump 1910 comprises an impeller, and an electrical motor for driving the impeller. In some embodiments, the pump 1910 may comprise a controller for controlling delivery of electrical power from the electrical energy storage 1908 to the electrical motor. The controller may comprise various control components as will be understood by a skilled artisan, including for example a feedback control. The controller may be used to permit, for example, throttling of the mass flow rate of the propellant, which may be beneficial for a variety of applications as will be apparent to those skilled in the art. As described herein, the propellant may be a fuel, such as liquid natural gas, and the pump 1910 may be used to pump the liquid natural gas to the rocket engine 1912. In some embodiments, a second separate pump (not shown) is used to pump an oxidant into the rocket engine 1912. The second pump may comprise a corresponding impeller, electrical motor for driving the impeller, and/or controller for controlling delivery of electrical power from the electrical energy storage 1908 to the electrical motor, as described with reference to the pump 1910.

The pump 1910 and/or the second pump may comprise an impeller configured to provide continuous, high mass flow rate pumping that is desired for high energy, limited duration applications such as launch vehicle applications. The impeller of the pump 1910 and/or the second pump may comprise one or more of a variety of types of electrical pumps. In some embodiments, the impeller of the pump 1910 and/or the second pump is an impeller-based impeller. A rotating impeller may be positioned between the propellant storage 1902 and the rocket engine 1912 to impel the fuel towards the rocket engine 1912, and/or between an oxidant storage and the rocket engine 1912 to impel the oxidant towards the rocket engine 1912. The pump 1910 and/or the second pump can be configured to provide a high mass flow rate of the fuel and/or oxidant, respectively, throughout the launching thrust time period for launch vehicle applications. In some embodiments, the pump 1910 and/or the second pump can be configured to deliver at least about 1,840 hp at operating rates of between about 9,600 to about 30,000 rpm for a period of about 100 seconds. In such applications, the pump 1910 and/or second pump may be configured to deliver LNG and/or LOx, respectively, at a very high mass flow rate, for example, at least about 400 Lbm/sec.

In some embodiments, the electrical motor of the pump 1910 includes a variable reluctance motor. In some embodiments, the motor includes a brushless DC motor. In some embodiments, the motor is configured to provide a substantially constant torque per amp over a wide range of operating speeds. In some embodiments, the motor allows for throttling speed variation from 0 to full speed. The speed of operation can be varied under pulse width modulated current control in response to signals from controller. In some embodiments, the motor can be configured to maintain an operating rate of about 9600 rpm for about 100 seconds and then to cease operation. In some embodiments, the pump 1910 may include a plurality of motors to achieve desired horsepower for driving an impeller, such as an impeller-based pump, of a launch vehicle or other high energy application. In some embodiments, a pair of motors may be used to drive the impeller, such as a pair of counter rotating motors. In some embodiments, each of the two motors can be configured to provide a power of about 440 horse power at about 10,000 rpm. In some embodiments, ten motors can be used to drive the impeller. For example, ten pumps each providing about 310 horse power motors can be used to provide about 3,100 horse power total to the impeller.

In some embodiments, the motor of the pump 1910 can be cryogenically cooled with the first propellant. For example, first propellant from the propellant storage 1902 can be supplied to the pump 1910 to facilitate cooling of the motor. The first propellant may be a liquid. In some embodiments, first propellant can be supplied to the motor of the pump 1910 such that the first propellant is in contact with one or more surfaces of the motor to provide cooling of the motor. In some embodiments, at least a portion of the first propellant used to cool the motor may be pumped to the heat exchanger 1904 and/or the rocket engine 1912. In some embodiments, at least a portion of the propellant used to cool the motor of the pump 1910 may be dumped overboard. In some embodiments, all of the first propellant leaving the motor is pumped to the heat exchanger 1904.

The pump 1910 can be configured to inject the first propellant to one or more portions of the rocket engine 1912. In some embodiments, the first propellant can be pumped to a main combustion chamber of the engine 1912. In some embodiments, the first propellant can be pumped to a nozzle portion of the rocket engine 1912. In some embodiments, the first propellant can be pumped to a portion below the nozzle portion, including a portion adjacent to and below the nozzle portion.

In some embodiments, the rocket engine can comprise an open expander cycle rocket engine. In some embodiments, the rocket engine can comprise other types of engines, such as a closed expander cycle rocket engine.

Including a heat exchanger configured to heat the propellant in generating electricity for powering an onboard pump may provide a high performance upgrade, such as in comparison to a liquid propellant supply system which uses other methods of generating electricity onboard to charge the batteries and supercapacitors. Such a configuration may provide desired high power delivery to the pump, allowing an electric drive system of the pump to be used in high power, limited duration applications such as continuously supplying a liquid propellant from a propellant storage to one or more portions of a rocket engine during a thrusting time period.

In some embodiments, one or more components of the rocket engine and liquid propellant supply system may be 3-D printed, such as using one or more methods of printing as described herein. In some embodiments, one or more components of the liquid propellant system can be 3-D printed. In some embodiments, all of the components of the rocket engine can be printed. In some embodiments, an injector and a chamber of the rocket engine can be 3-D printed. In some embodiments, a main valve can be printed. In some embodiments, a pump of the liquid propellant system can be 3-D printed. In some embodiments, an impeller of the liquid propellant can be 3-D printed.

In some embodiments, metal 3D printing can be utilized to print the rocket engine for its orbital launch vehicle using Direct Metal Laser Sintering technology (DMLS). DMLS printing parameters can be generated for the engine's unique requirements, such as material properties, as-designed vs. as-printed variation, and surface finish.

In some embodiments, a pump and main valve for the rocket engine can be 3-D printed, including 3-D printing which comprises DMLS technology. In some embodiments, SLM 280 can be used for engine chamber, injector, valve, and pump components.

In the embodiment, the engine is a regeneratively cooled electric pump-fed engine using Liquid Oxygen (LOX) and Liquid Natural Gas (LNG) as propellants.

In some embodiments, the rocket engine includes a 3D printed shear-coaxial baffled element injector and a regeneratively cooled chamber using LOX and LNG as propellants. In some embodiments, this engine can power both stages of the launch vehicle.

In some embodiments, a pump and main valve for the rocket engine (e.g., rocket engine) can be 3-D printed as described herein.

In some embodiments, one or more components of the rocket are 3-D printed. In some embodiments, manufacturing one or more components of the rocket comprises one or more 3-D printing processes described herein. A 3-D printing process comprising DMLS printing can be performed. The printed component can be subject to a powder removal. Subsequent to powder removal, an ultrasonic clean can be performed, followed by a solution anneal. In some embodiments, a milling process can follow. Another ultrasonic clean can be performed after the milling process. Age harden can be done after the ultrasonic clean, followed by a pressure proof process. The component can then be subjected to a water flow process, followed by a CT scan to inspect the component. In some embodiments, the component can be subjected to a final oxygen clean.

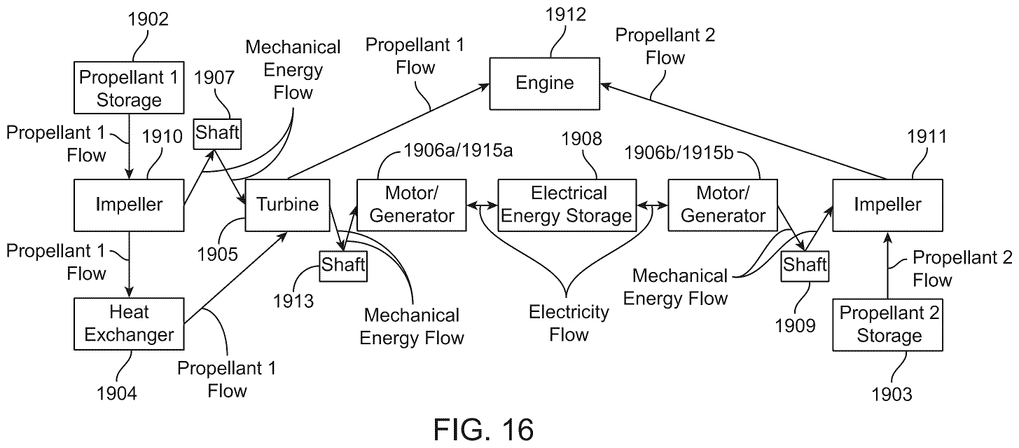

FIGS. 16-27 show schematic diagrams of exemplary liquid propellant supply systems 1900 for supplying multiple propellants to a rocket engine 1912 of a launch vehicle. The liquid propellant systems disclosed herein generally comprise at least an engine, an impeller, a turbine, and a motor. The impeller, turbine and motor may be referred to as a turbine-impeller-motor assembly. The rocket engine 1912 may be configured to generate sufficient thrust for launching a launch vehicle comprising one or more stages away from earth. Liquid propellant supply systems 1900 disclosed herein generally include a first propellant storage 1902, a second propellant storage 1903, a heat exchanger 1904, a motor 1906, an electrical energy storage 1908, a first impeller 1910, and a second impeller 1911. Any one of the systems disclosed herein may comprise a heat exchanger 1904. Alternatively or additionally to the heat exchanger 1904, some systems disclosed herein comprise at least one component selected from a gas generator and a pre-burner. In some instances, the gas generator or pre-burner combusts a propellant disclosed herein to produce a heated working fluid. In some instances, the heated working fluid flows through the turbine. In some embodiments, the heated working fluid flowing through the turbine rotates a turbine shaft of the turbine. In some embodiments, the rotation of the turbine shaft of the turbine drives the impeller. In some embodiments, the rotation of the turbine shaft of the turbine is connected to the electrical generator 1915. Gas generator and pre-burner engine cycles allow the system to be scaled to larger vehicles because they can provide more power to pump propellant than with a regenerative cooling circuit alone.

Liquid propellant supply systems 1900 disclosed herein may comprise a first motor 1906a and a second motor 1906b. In some instances, the system comprises an electrical generator 1915, also simply referred to herein as a “generator.” In some cases, the motor and the electrical generator are integrated, and referred to as a motor/generator. In some instances, integrating the motor and generator into a single motor/generator reduces the weight of the system and enables the vehicle to deliver more payload to orbit. In some cases, the motor and the electrical generator are separate. Liquid propellant supply systems 1900 disclosed herein may comprise a first generator 1906a and a second generator 1906b.

The first propellant can be supplied from the first propellant storage 1902 to the first impeller 1910, and the first impeller 1910 can impel the first propellant to the rocket engine 1912 and/or the heat exchanger 1904. In some embodiments, the first propellant may be split and supplied both to the rocket engine 1912 and the heat exchanger 1904.

In some instances, the turbine-impeller-motor assembly has at least two separate shafts. As exemplified in FIG. 16, a first portion of the first propellant flowed through the heat exchanger 1904 can be flowed through the turbine 1905 to the rocket engine 1912. A second portion of the first propellant can be pumped by the first impeller 1910 to rotate a turbine shaft 1907 which thereby drives the turbine. The turbine 1905 may comprise rotatable turbine shafts coupled to a motor shaft 1913 that drives the first motor/generator 1906a/1915a to generate electricity.

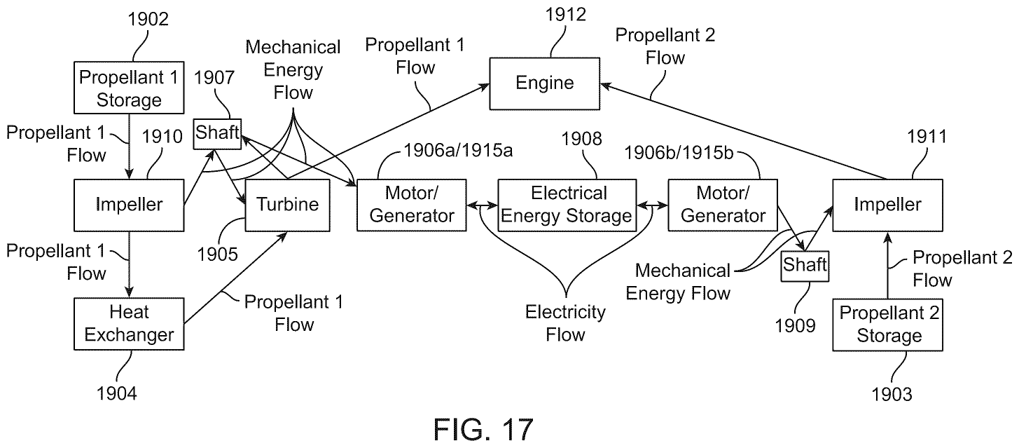

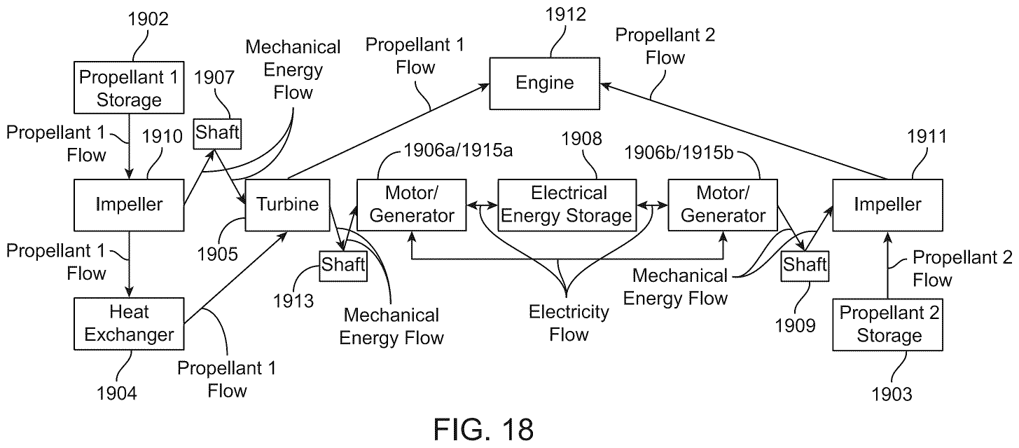

In some instances, the turbine-impeller-motor assembly has a common shaft. As exemplified in FIG. 17, a first portion of the first propellant flowed through the heat exchanger 1904 can be flowed through the turbine 1905 to the rocket engine 1912. A second portion of the first propellant can be pumped by the first impeller 1910 to rotate a turbine shaft 1907 which thereby drives the turbine 1905 and the first motor/generator 1906a/1915a. In turn, the turbine provides mechanical energy back to the shaft. In this instance, a generator shaft is not necessary, and the turbine shaft 1907 is considered a common shaft or a motor/turbine shaft.

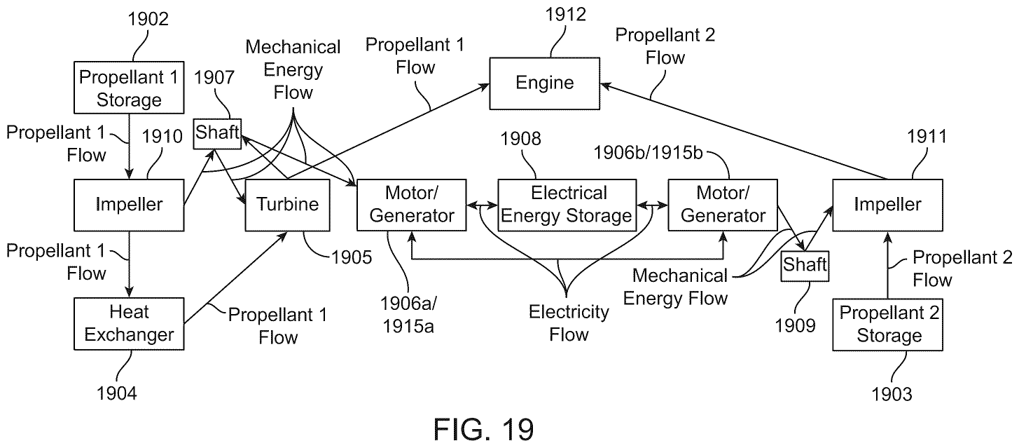

In some instances, there is direct electrical energy flow between the first motor/generator 1906a/1915a and the second motor/generator 1906b/1915b, as exemplified in FIG. 18 and FIG. 19. In some instances, this direct electrical energy flow allows electrical power generated from one motor/generator to electrically power the other motor/generator without storing this electrical energy in the electrical storage or passing the electrical energy through the electrical energy storage. Passing or storing the energy in the electrical energy storage reduces the life of the electrical energy storage and is more inefficient.

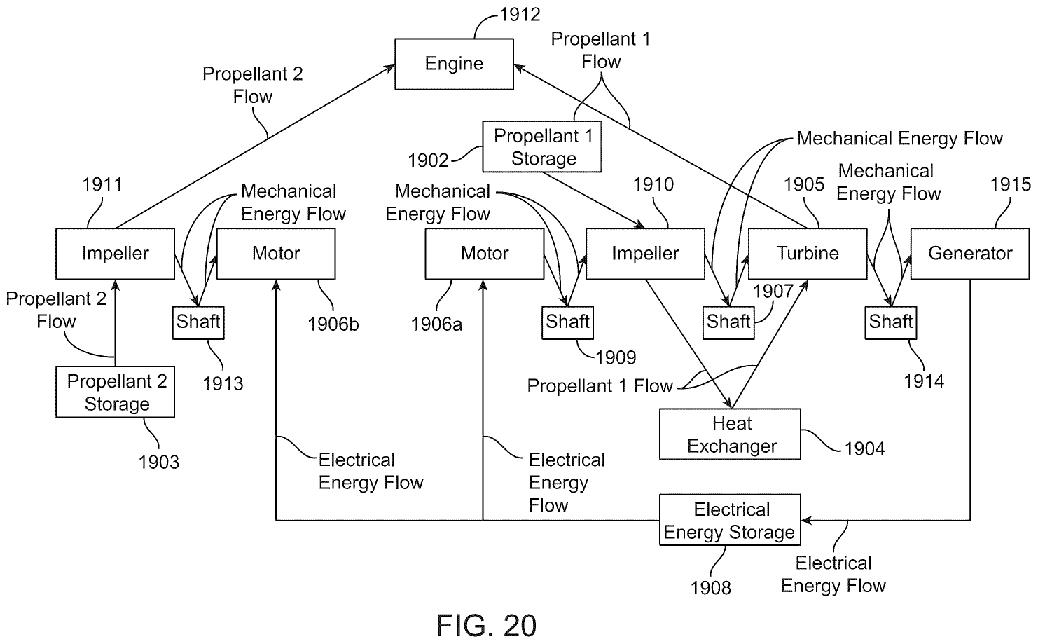

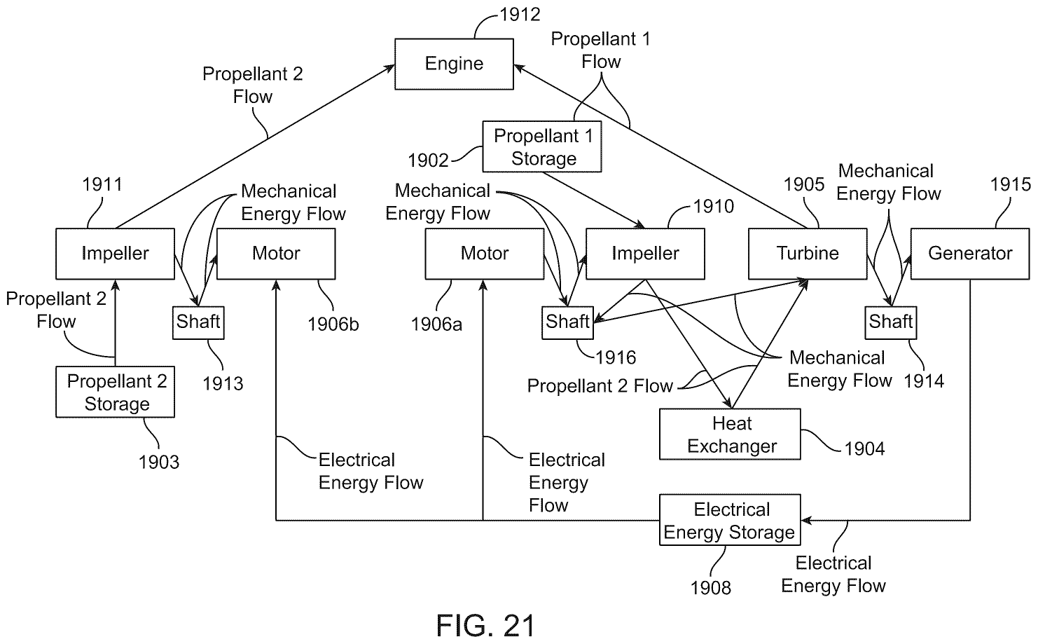

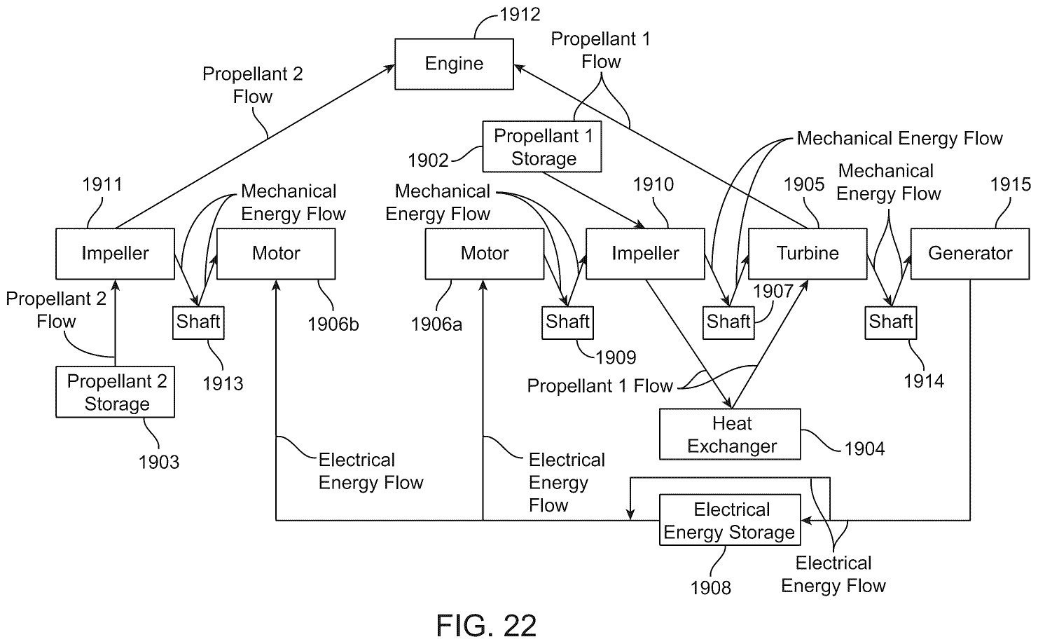

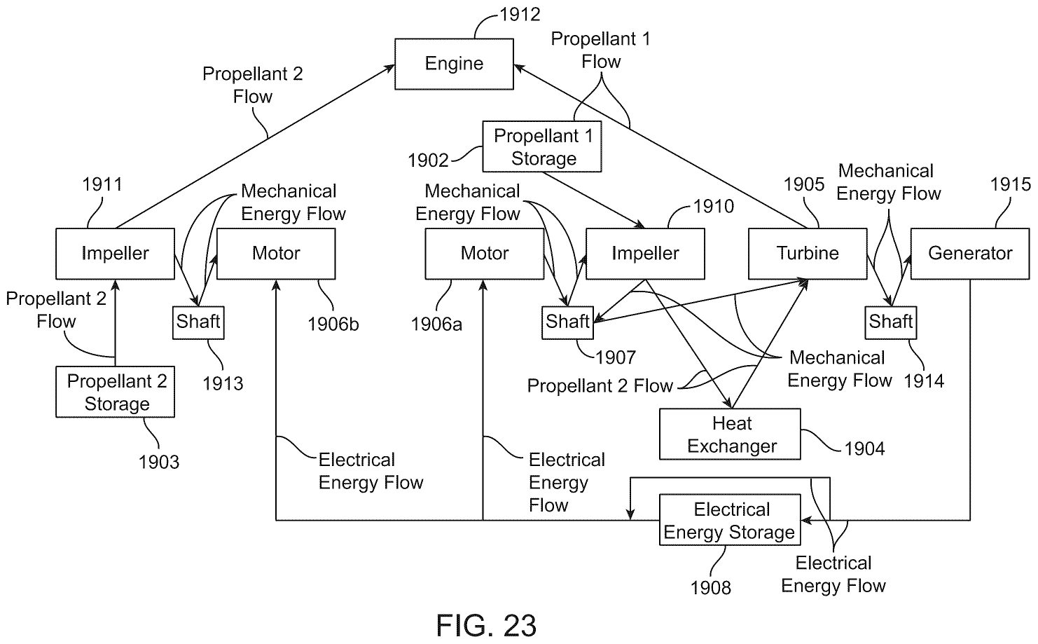

As exemplified in FIGS. 20 and 21, a first portion of the first propellant flowed through the heat exchanger 1904 can be flowed through the turbine 1905 to the rocket engine 1912. The turbine (1905) can drive the motor shaft 1913, which further drives the electrical generator 1915 to produce energy that is stored in the electrical energy storage 1908. Electrical energy from the electrical energy storage 1908 may then be used to power the motors 1906a, 1906b. In some instances, as shown in FIG. 20 the first motor 1906a can drive the impeller shaft 1909 to power the first impeller. In some instances, as exemplified in FIG. 21, the first motor 1906a can drive an impeller/turbine shaft 1916 to power the first impeller and the turbine. The first impeller may return a portion of the power back to the impeller/turbine shaft 1916. In some instances, a second propellant flows through a second impeller 1911, to the engine 1912 and drives the turbine shaft 1907 to power the first motor 1906a. In some instances, a second propellant flows through a second impeller 1911, to the engine 1912 and drives the turbine shaft 1907 to power the second motor 1906b. In some instances, the liquid propellant supply system 1900 comprises an optional direct electrical energy storage bypass. See, e.g., FIGS. 22 and 23. This optional direct electrical energy storage bypass allows electrical power generated from the generator 1915 to power at least one of the first motor 1906a or second motor 1906b without storing this electrical energy in the electrical energy storage. Such a battery bypass can be advantageous because storing energy in the electrical energy storage or passing energy through the electrical energy storage can reduce the life of the electrical energy storage and can be an inefficient means of routing energy.

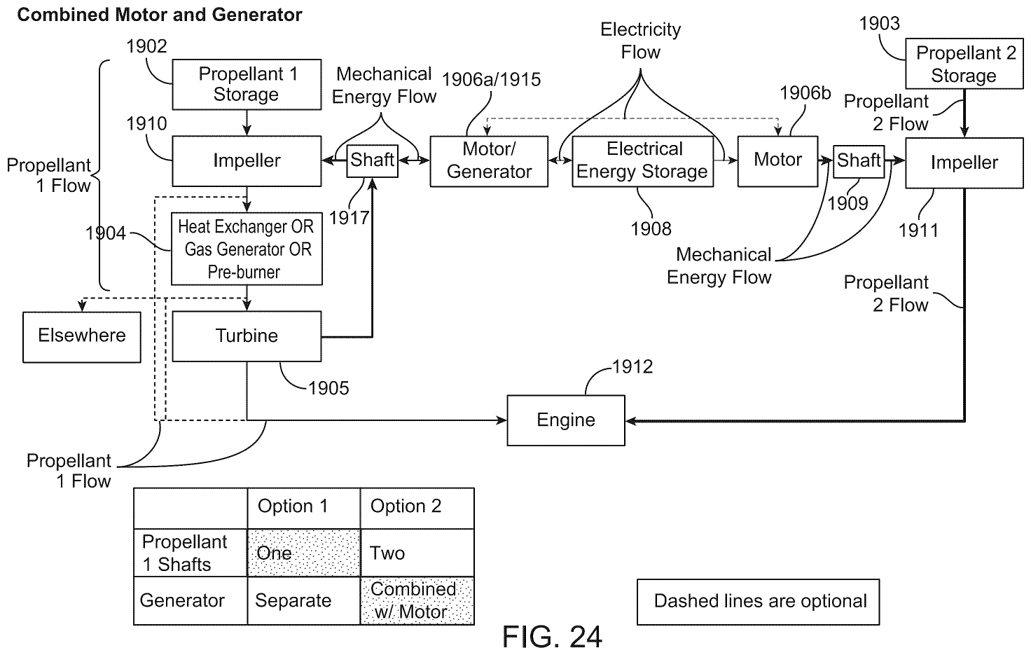

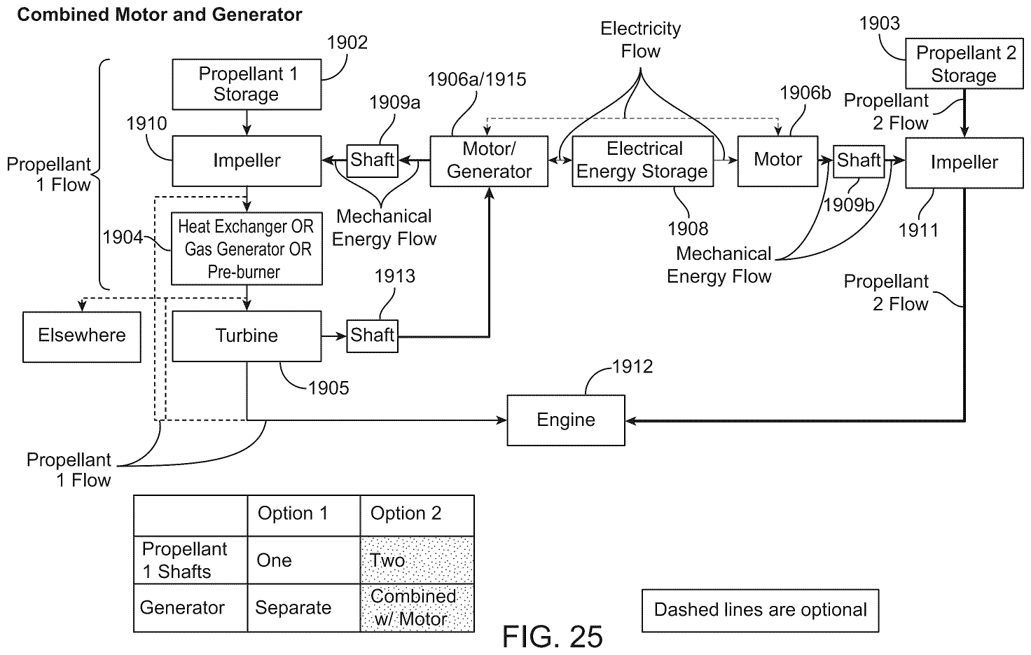

In some instances, as exemplified in FIG. 24 the liquid propellant supply system 1900 comprises an impeller/motor shaft 1917. The turbine 1905 may be connected to the impeller/motor shaft 1917 as the impeller spins the motor/generator and generates electricity. The first propellant exiting the turbine 1905 can be (1) fed into the rocket engine 1912, (2) used for autogenous pressurization, and/or (3) dumped overboard. In some instances, as exemplified in FIG. 25, the turbine 1905 may also drive a motor shaft 1913 to generate electricity. In some instances, as shown in FIGS. 25-27, a motor/generator 1906a/1915 or a first motor 1906a drives a first impeller shaft 1909a and a second motor 1906b drives a second impeller shaft 1909b. In some instances, at least a portion of the first propellant is heated or combusted in the heat exchanger. In some instances, at least a portion of the first propellant that is heated or combusted in the heat exchanger goes through the turbine. In some instances, at least a portion of the first propellant that is heated or combusted in the heat exchanger goes elsewhere, sec, e.g., FIG. 25. Non-limiting examples of elsewhere include, a propellant tank, a reaction control thruster, an accumulator, and an igniter, and combinations thereof. In some instances, at least a portion of the first propellant that is heated or combusted in the heat exchanger pressurizes a propellant tank. In some instances, at least a portion of the first propellant that is heated or combusted in the heat exchanger feeds a reaction control thruster. In some instances, at least a portion of the first propellant that is heated or combusted in the heat exchanger is stored in an accumulator. In some instances, at least a portion of the first propellant that is heated or combusted feeds an igniter. In addition, mechanical energy flow from the second motor 1906b can rotate an impeller shaft 1909 to drive the second impeller 1911.

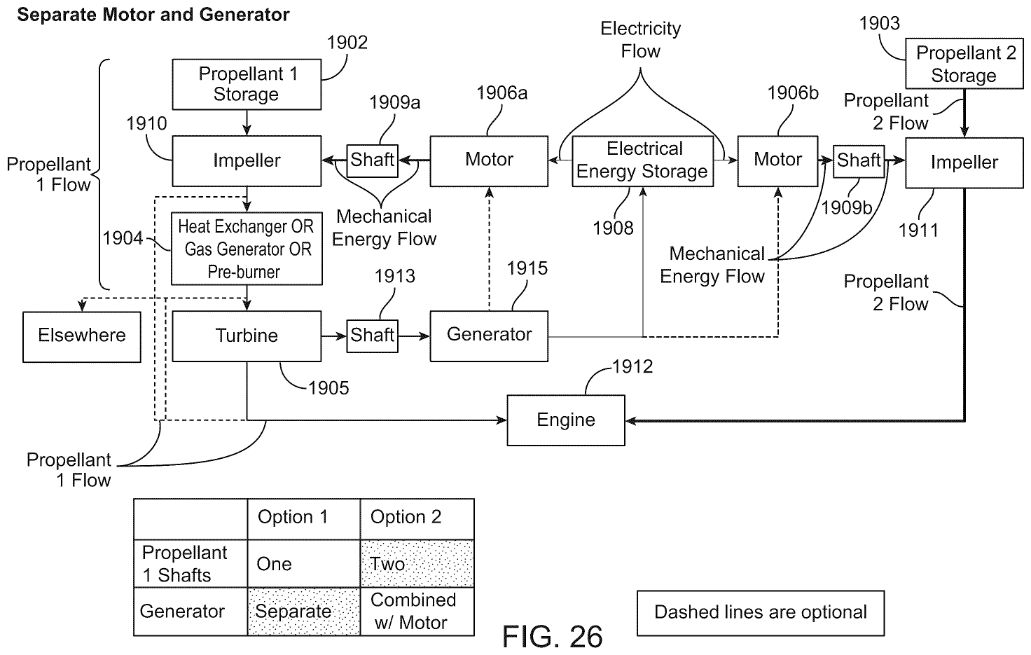

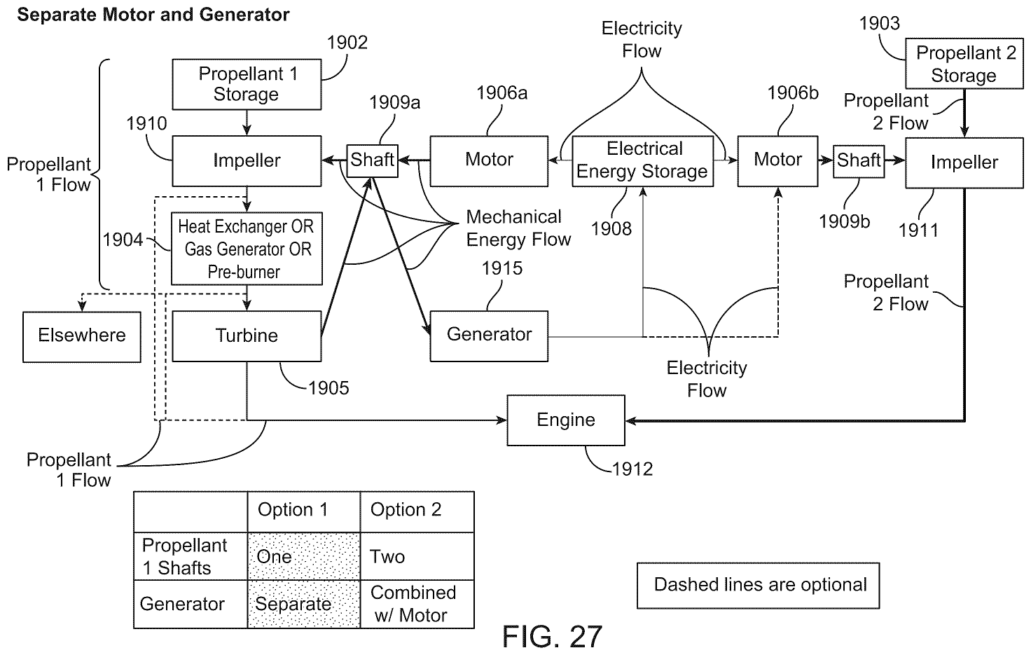

In some instances, such as those exemplified in FIGS. 24 and 25, the system comprises a combined motor/generator 1906/1915. In some instances, such as those exemplified in FIGS. 26 and 27, the system comprises a separate motor and generator.

Electricity generated by the first motor 1906a and/or second motor 1906b can be stored in the electrical energy storage 1908. Mechanical energy generated by the second motor 1906b may be used to power a second impeller 1911 different from the first impeller 1910 to propel a second propellant to the rocket engine 1912. In some embodiments, the first propellant may comprise a fuel and the second propellant may comprise an oxidant. By way of non-limiting example, the first propellant may be liquid natural gas (LNG) and the second propellant may be liquid oxygen (LNG).

### Second Stage

In some embodiments, one or more portions of a second stage of a rocket can be 3-D printed. In some embodiments, the second stage can be entirely 3-D printed. In some embodiments, the thrust load can be transferred through an integral thrust structure at the aft end of the stage and transferred directly to the stage hold-down structure. In some embodiments, the pump/main valve assembly is plumbed directly to the tank structure to deliver high pressure LOX and LNG to the engine. Fuel can be flowed through cooling channels in the chamber and injected as a supercritical gas. In some embodiments, about 1% of this flow is tapped off near the injector dome and redirected to the fuel tank for autogenous pressurization. LOX can be pumped directly to the injector. In some embodiments, the LOX can be pumped to the injector via a small bypass heat exchanger for autogenously pressurizing the oxidizer tank.

### EXAMPLES

The examples and embodiments described herein are for illustrative purposes only and are not intended to limit the scope of the claims provided herein. Various modifications or changes suggested to persons skilled in the art are to be included within the spirit and purview of this application and scope of the appended claims.

### Example 1. Rocket Propellant System: Integrated Motor and Generator with Separate Turbine and Motor Shafts

A liquid propellant supply system for supplying multiple propellants to a rocket engine of a launch vehicle is manufactured with an ALM device. Such a liquid propellant system 1900 is represented in FIGS. 16 and 18, provided herein. The liquid propellant system has an engine 1912, two impellers 1910 and 1911 that pump propellants from different propellant storages 1902 and 1903, a heat exchanger 1904, and a turbine 1905. Alternatively or additionally to the heat exchanger 1904, the system has a gas generator or a pre-burner, either of which can burn/combust the propellant instead of merely heating it. Heated propellant or heated working fluid from the heat exchanger or generator/pre-burner, respectively, flows through the turbine rotating a shaft of the turbine.

The first propellant is supplied from the first propellant storage 1902 to the first impeller 1910, and the first impeller 1910 impels the first propellant to the rocket engine 1912 and the heat exchanger 1904. A first portion of the first propellant flows through the heat exchanger 1904, and through the turbine 1905, to the rocket engine 1912. A second portion of the first propellant is pumped by the first impeller 1910 to rotate a turbine shaft 1907 which thereby drives the turbine. The turbine 1905 has rotatable shafts coupled to a motor shaft 1913 that drives the first motor/generator 1906a/1915a to generate electricity.

In this case, the liquid propellant system has a two-part integrated motor/generator. As shown in FIG. 16, there is a first part of the integrated motor/generator 1906a/1915a and a second part of the integrated motor/generator 1906b/1915b. Energy from the electrical energy storage 1908 powers the second motor/generator 1906b/1915b. Some of the electricity generated by the first generator 1915a and the second generator 1915b is stored in the electrical energy storage 1908. Optionally, there is a path for direct electricity flow between the first part of the integrated motor/generator 1906a/1915a and the second part of the integrated motor/generator 1906b/1915b, as shown in FIG. 18.

Mechanical energy generated by the second motor 1906b powers a second impeller 1911 different from the first impeller 1910 to propel a second propellant to the rocket engine 1912.

Mechanical energy from rotation of the turbine shaft and electrical energy from the electrical energy storage drive the impellers to pump the propellants into the rocket engine for thrust during launching.

### Example 2. Rocket Propellant System: Integrated Motor and Generator with Common Turbine and Motor Shaft

A liquid propellant supply system for supplying multiple propellants to a rocket engine of a launch vehicle is manufactured with an ALM device. Such a liquid propellant system 1900 is represented in FIG. 17 and FIG. 19, provided herein. The liquid propellant system has an engine 1912, two impellers 1910 and 1911 that pump propellants from different propellant storages 1902 and 1903, a heat exchanger 1904, and a turbine 1905. Alternatively or additionally to the heat exchanger 1904, the system has a gas generator or a pre-burner, either of which can burn/combust the propellant instead of merely heating it. Heated propellant or heated working fluid flows through the turbine rotating a turbine shaft of the turbine.

The first propellant is supplied from the first propellant storage 1902 to the first impeller 1910, and the first impeller 1910 impels the first propellant to the rocket engine 1912 and the heat exchanger 1904. As represented in FIG. 17, a first portion of the first propellant flows through the heat exchanger 1904 and through the turbine 1905 to the rocket engine 1912. A second portion of the first propellant is pumped by the first impeller 1910 to rotate a turbine shaft 1907 which thereby drives the turbine 1905 and the first motor/generator 1906a/1915a. In turn, the turbine provides mechanical energy back to the turbine shaft 1907. In this instance, a separate motor/generator shaft as demonstrated in Example 1 is not necessary. Instead, the turbine shaft 1907 is considered a common motor/generator/turbine shaft.

In this case, the liquid propellant system has a two-part integrated motor/generator. As shown in FIG. 17, there is a first part of the integrated motor/generator 1906a/1915b and a second part of the integrated motor/generator 1906b/1915b. Energy from the electrical energy storage 1908 also powers the second motor/generator 1906b/1915b. Some of the electricity generated by the first motor 1906a and the second motor 1906b is stored in the electrical energy storage 1908. Optionally, there is a path for direct electricity flow between the first part of the integrated motor/generator 1906a/1915a and the second part of the integrated motor/generator 1906b/1915b, as shown in FIG. 19.

Mechanical energy generated by the second motor 1906b powers a second impeller 1911 different from the first impeller 1910 to propel a second propellant to the rocket engine 1912.

Mechanical energy from rotation of the turbine shaft and electrical energy from the electrical energy storage drive the impellers to pump the propellants into the rocket engine for thrust during launching.

### Example 3. Rocket Propellant System with Separate Motors and Generator

A liquid propellant supply system for supplying multiple propellants to a rocket engine of a launch vehicle is manufactured with an ALM device. Such a liquid propellant system 1900 is represented in FIGS. 20-23, provided herein. The liquid propellant system has an engine 1912, two impellers 1910 and 1911 that pump propellants from different propellant storages 1902 and 1903, a heat exchanger 1904, and a turbine 1905. Alternatively or additionally to the heat exchanger 1904, the system has a gas generator or a pre-burner, either of which can burn/combust the propellant instead of merely heating it. Heated propellant or heated working fluid flows through the turbine rotating a turbine shaft of the turbine.

The first propellant is supplied from the first propellant storage 1902 to the first impeller 1910, and the first impeller 1910 pumps a first portion of the first propellant flows through the heat exchanger 1904 and through the turbine 1905 to the rocket engine 1912. A second portion of the first propellant is pumped by the first impeller 1910 to rotate a turbine shaft 1907 which thereby drives the turbine 1905. In turn, the turbine provides mechanical energy to a generator shaft 1914, powering the generator 1915. The generator then sends electrical energy flow to a first motor 1906a and a second motor 1906b. Alternatively or additionally, the generator sends electrical energy flow to an electrical energy storage 1908.

As shown in FIG. 20 the first motor 1906a can drive the impeller shaft 1909 to power the first impeller. Alternatively, as exemplified in FIG. 21, the first motor 1906a can drive a common impeller/turbine shaft 1916 to power the first impeller 1910 and the turbine 1905. The first impeller 1910 returns a portion of the power back to the impeller/turbine shaft 1916.

A second propellant flows through a second impeller 1911, to the engine 1912 and drives the turbine shaft 1907 to power the first motor 1906a. The second propellant also flows through the second impeller 1911, to the engine 1912 and drives the motor shaft 1913 to power the second motor 1906b.

Optionally, the liquid propellant supply system 1900 has a battery bypass, represented by the arrow circumventing the electrical energy storage 1908 in FIGS. 22 and 23.

Mechanical energy generated by the second motor 1906b powers a second impeller 1911 different from the first impeller 1910 to propel a second propellant to the rocket engine 1912.

Mechanical energy from rotation of the turbine shaft and electrical energy from the electrical energy storage drive the impellers to pump the propellants into the rocket engine for thrust during launching.

### Example 4. Rocket Propellant System: Integrated Motor and Generator with Common Impeller and Motor Shaft

A liquid propellant supply system for supplying multiple propellants to a rocket engine of a launch vehicle is manufactured with an ALM device. Such a liquid propellant system 1900 is represented in FIG. 24, provided herein. The liquid propellant system has an engine 1912, two impellers 1910 and 1911 that pump propellants from different propellant storages 1902 and 1903, a heat exchanger 1904, and a turbine 1905. Alternatively or additionally to the heat exchanger 1904, the system has a gas generator or a pre-burner, either of which can burn/combust the propellant instead of merely heating it. Heated propellant or heated working fluid flows through the turbine rotating a turbine shaft of the turbine.

The first propellant is supplied from the first propellant storage 1902 to the first impeller 1910, and the first impeller 1910 pumps a first portion of the first propellant through the heat exchanger 1904 and through the turbine 1905 to the rocket engine 1912. A second portion of the first propellant is pumped by the first impeller 1910 through the turbine 1905 to rotate a common impeller/motor shaft 1917. The impeller/motor shaft 1917 provides mechanical energy to in turn power the first impeller 1910 as well as an integrated motor/generator 1906a/1915. The generator 1915 sends electrical energy flow to an electrical energy storage 1908. Electrical energy from the electrical energy storage 1908 powers a second motor 1906b. Alternatively or additionally, the integrated motor/generator 1906a/1915 directly powers the second motor 1906b. Mechanical energy generated by the second motor 1906b is used to power a second impeller 1911 different from the first impeller 1910 to propel a second propellant to the rocket engine 1912. Optionally, a portion of the first propellant is routed elsewhere or dumped overboard.

Mechanical energy generated by the second motor 1906b powers a second impeller 1911 different from the first impeller 1910 to propel a second propellant to the rocket engine 1912.

Mechanical energy from rotation of the turbine shaft and electrical energy from the electrical energy storage drive the impellers to pump the propellants into the rocket engine for thrust during launching.

### Example 5. Rocket Propellant System: Integrated Motor and Generator with Separate Impeller and Motor Shaft

A liquid propellant supply system for supplying multiple propellants to a rocket engine of a launch vehicle is manufactured with an ALM device. Such a liquid propellant system 1900 is represented in FIG. 25, provided herein. The liquid propellant system has an engine 1912, two impellers 1910 and 1911 that pump propellants from different propellant storages 1902 and 1903, a heat exchanger 1904, and a turbine 1905. Alternatively or additionally to the heat exchanger 1904, the system has a gas generator or a pre-burner, either of which can burn/combust the propellant instead of merely heating it. Heated propellant or heated working fluid flows through the turbine rotating a turbine shaft of the turbine.

The first propellant is supplied from the first propellant storage 1902 to the first impeller 1910, and the first impeller 1910 pumps a first portion of the first propellant through the heat exchanger 1904 and through the turbine 1905 to the rocket engine 1912. A second portion of the first propellant is pumped by the first impeller 1910 through the turbine 1905 to drive a motor shaft 1913 that provides mechanical energy to power an integrated motor/generator 1906a/1915. The integrated first motor/generator 1906a/1915 drives a first impeller shaft 1909a to in turn power the first impeller 1910 as well as send electrical flow to an electrical energy storage 1908. The electrical energy storage 1908 provides electrical energy to power a separate second motor 1906b. Alternatively or additionally, the integrated first motor/generator 1906a/1915 sends energy directly to the second motor 1906b. Mechanical energy generated by the second motor 1906b may be used drive a second impeller shaft 1909b to power a second impeller 1911 to propel a second propellant to the rocket engine 1912. Optionally, a portion of the first propellant is routed elsewhere or dumped overboard.

Mechanical energy generated by the second motor 1906b powers a second impeller 1911 different from the first impeller 1910 to propel a second propellant to the rocket engine 1912.

Mechanical energy from rotation of the turbine shaft and electrical energy from the electrical energy storage drive the impellers to pump the propellants into the rocket engine for thrust during launching.

### Example 6. Rocket Propellant System: Separate Motor and Generator with Separate Impeller and Generator Shafts

A liquid propellant supply system for supplying multiple propellants to a rocket engine of a launch vehicle is manufactured with an ALM device. Such a liquid propellant system 1900 is represented in FIG. 26, provided herein. The liquid propellant system has an engine 1912, two impellers 1910 and 1911 that pump propellants from different propellant storages 1902 and 1903, a heat exchanger 1904, and a turbine 1905. Alternatively or additionally to the heat exchanger 1904, the system has a gas generator or a pre-burner, either of which can burn/combust the propellant instead of merely heating it. Heated propellant or heated working fluid flows through the turbine rotating a turbine shaft of the turbine.

The first propellant is supplied from the first propellant storage 1902 to the first impeller 1910, and the first impeller 1910 pumps a first portion of the first propellant through the heat exchanger 1904 and through the turbine 1905 to the rocket engine 1912. A second portion of the first propellant is pumped by the first impeller 1910 through the turbine 1905 to drive a generator shaft 1914. The generator shaft 1914 provides mechanical energy to in turn power a generator 1915. The generator provides electrical energy to a first motor 1906a which in turn drives the first impeller shaft 1909a to in turn power the first impeller 1910, as well as send electrical flow to an electrical energy storage 1908. The electrical energy storage 1908 provides electrical energy to power a separate second motor 1906b. Alternatively or additionally, the generator 1915 sends energy directly to the second motor 1906b. Mechanical energy generated by the second motor 1906b may be used drive a second impeller shaft 1909b to power a second impeller 1911 to propel a second propellant to the rocket engine 1912. Optionally, a portion of the first propellant is routed elsewhere or dumped overboard.

Mechanical energy generated by the second motor 1906b powers a second impeller 1911 different from the first impeller 1910 to propel a second propellant to the rocket engine 1912.

Mechanical energy from rotation of the turbine shaft and electrical energy from the electrical energy storage drive the impellers to pump the propellants into the rocket engine for thrust during launching.

### Example 7. Rocket Propellant System: Separate Motor and Generator with Common Impeller and Generator Shaft

A liquid propellant supply system for supplying multiple propellants to a rocket engine of a launch vehicle is manufactured with an ALM device. Such a liquid propellant system 1900 is represented in FIG. 27, provided herein. The liquid propellant system has an engine 1912, two impellers 1910 and 1911 that pump propellants from different propellant storages 1902 and 1903, a heat exchanger 1904, and a turbine 1905. Alternatively or additionally to the heat exchanger 1904, the system has a gas generator or a pre-burner, either of which can burn/combust the propellant instead of merely heating it. Heated propellant or heated working fluid flows through the turbine rotating a turbine shaft of the turbine.

The first propellant is supplied from the first propellant storage 1902 to the first impeller 1910, and the first impeller 1910 pumps a first portion of the first propellant through the heat exchanger 1904 and through the turbine 1905 to the rocket engine 1912. A second portion of the first propellant is pumped by the first impeller 1910 through the turbine 1905 to drive a common first impeller/generator shaft 1909a that powers the first impeller 1910 as well as a generator 1915. The generator provides electrical energy to an electrical energy storage 1908. The electrical energy storage 1908 provides electrical energy to power a separate second motor 1906b. Alternatively or additionally, the generator 1915 sends energy directly to the second motor 1906b. The electrical energy storage 1908 also provides electrical energy back to the first motor 1906a. Mechanical energy generated by the second motor 1906b may be used drive a second impeller shaft 1909b to power a second impeller 1911 to propel a second propellant to the rocket engine 1912. Optionally, a portion of the first propellant is routed elsewhere or dumped overboard.

Mechanical energy generated by the second motor 1906b powers a second impeller 1911 different from the first impeller 1910 to propel a second propellant to the rocket engine 1912.

Mechanical energy from rotation of the turbine shaft and electrical energy from the electrical energy storage drive the impellers to pump the propellants into the rocket engine for thrust during launching.

A number of embodiments of the invention have been described. Nevertheless, it will be understood that various modifications may be made without departing from the spirit and scope of the invention. Accordingly, other embodiments are within the scope of the following claims.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method, comprising:
applying an amount of heat to a portion of a layer of a metallic workpiece sufficient to melt the portion of the layer of the metallic workpiece thereby forming a melt pool portion of the metallic workpiece;
depositing a feed wire comprising a metallic deposition material to the melted pool portion of the layer of the metallic workpiece to form a layer of metallic deposition material on the metallic workpiece;
cooling the deposited layer of metallic deposition material on the metallic workpiece to solidify the deposited layer; and
repeating the applying, depositing, and cooling to form a plurality of deposited layers;
wherein at least a portion of the metallic deposition material is deposited in an offset location relative to a desired final location within the plurality of deposited layers by controlling at least one of: a layer orientation, a deposition direction, a melt pool width, a melt pool thickness, a width of the layer of metallic deposition material, grain solidification, heat input, and an alloy gradient, such that deformation of the metallic deposition material upon cooling or solidifying translates the metallic deposition material from the offset location to the desired final location within the plurality of deposited layers.

2. The method of claim 1, wherein the metallic deposition material comprises at least one alloy selected from the group consisting of: an aluminum (Al) alloy, an aluminum scandium (Al—Sc) alloy, an aluminum titanium boron (Al—Ti—B) alloy, an aluminum titanium carbon (Al—Ti—C) alloy, and an aluminum niobium boron (Al—Nb—B) alloy.

3. The method of claim 1, wherein the plurality of deposited layers forms a portion of an orbital vehicle or a launch vehicle; wherein the portion of the orbital or the launch vehicle is selected from the group consisting of: a dome section, an aft dome of a second stage, a barrel section, a storage tank, a fuel injector with a propellant line, a combustion chamber, a rocket engine, a nozzle extension structure, and a shell-like structural component with a diameter greater than 1 meter, of the orbital vehicle or the launch vehicle.

4. The method of claim 1, further comprising applying a stress relieving process directly to the cooled deposited layer.

5. The method of claim 4, wherein the stress relieving process comprises a pulsed laser treatment or an ultrasonic treatment to at least a portion of the metallic workpiece.

6. The method of claim 1, further comprising cooling at least a portion of the deposited layer of metallic deposition material such that an internal stress is generated to produce at least one of: a selective pre-tensioning and a selective pre-compressing within the plurality of deposited layers.

7. The method of claim 1, further comprising depositing the feed wire from a print arm, moving at least one of: the print arm and the metallic workpiece, to form the layer of metallic deposition material on the metallic workpiece.

8. The method of claim 7, wherein the print arm moves an apparatus that comprises a wire feeder.

9. The method of claim 7, further comprising using the print arm to move a trowel to control a melt pool geometry.

10. The method of claim 3, further comprising at least one of: drilling, milling, turning, grinding, broaching, reaming, shot peening, grit blasting, polishing, machining, electrical discharge machining, and electro-chemical machining, the metallic workpiece to form the portion of the orbital vehicle or the launch vehicle.

11. The method of claim 1, wherein a closed loop control system automatically controls applying the amount of heat to the portion of the layer of the metallic workpiece and cooling the deposited layer of metallic deposition material.

12. An apparatus, comprising:
an optic device configured to focus an energy beam on to a layer of a workpiece such that an amount of heat from the energy beam is sufficient to form a melted portion of the workpiece;
an applicator configured to deposit a feed wire comprising a metallic deposition material to the melted portion of the workpiece to form a layer of deposition material on the workpiece;
a cooling apparatus configured to cool the layer of deposition material on the workpiece to solidify the deposited layer; and
a stress-relieving apparatus configured to apply a stress-relieving process on the cooled layer of deposition material on the workpiece.

13. The apparatus of claim 12, wherein the stress-relieving apparatus comprises a peening module configured to apply a high frequency peening process to the solidified deposited layer, wherein the high frequency peening process comprises applying at least one of: a pulsed laser treatment and an ultrasonic impact treatment to the solidified deposited layer.

14. The apparatus of claim 12, wherein the cooling apparatus uses at least one of: a gas cooling, a liquid cooling, and a cryogenic cooling.

15. The apparatus of claim 12, further comprising a wire straightening apparatus comprising at least one of: a roller arrangement, a static blade arrangement, and a heating device.

16. The apparatus of claim 15, wherein the heating device heats up the feed wire by at least one of: electric resistive heating, inductive heating, radiative heating, conduction heating, and convective heating.

17. The apparatus of claim 12, further comprising at least one of: a tensioning element, a roller device, and a trowel device.

18. The apparatus of claim 17, further comprising a movable armature, wherein at least one of: the trowel device and the roller device is attached to the applicator by the movable armature.

19. The apparatus of claim 17, wherein the trowel device comprises a material selected from a ceramic material and a refractory metallic material.

20. The apparatus of claim 12, further comprising a wire feeder system or a wire feeder guide tip mounted on a print head to feed the feed wire.

21. The apparatus of claim 12, wherein the optic device comprises a laser.

22. The apparatus of claim 12, further comprising a monitor and controller configured to monitor and control at least one of: a wire temperature prior to the heat, a workpiece temperature, a temperature surrounding the workpiece, a module location with reference to the workpiece, and a real time location and temperature of a surface of the workpiece.
